(19) United States
(12) Patent Application Publication
(10) Pub. No.: US 2024/0243936 A1
(43) Pub. Date: Jul. 18, 2024

(54) CHARGING FOR EDGE ENABLING INFRASTRUCTURE RESOURCES

(71) Applicant: Intel Corporation, Santa Clara, CA (US)

(72) Inventors: Yizhi YAO, Chandler, AZ (US); Joey CHOU, Santa Clara, CA (US)

(21) Appl. No.: 18/558,604

(22) PCT Filed: Dec. 12, 2022
(86) PCT No.: PCT/US2022/052574

§ 371 Date: Nov. 2, 2023

Related U.S. Application Data
(60) Provisional application No. 63/295,387, filed on Dec. 30, 2021.

(51) Int. Cl. H04L 12/14; H04L 41/0823; H04L 43/0876

(52) U.S. Cl. CPC H04L 12/1407; H04L 41/0823; H04L 43/0876

(57) ABSTRACT

Various embodiments herein relate to a logical element configured to consume a management service (MnS). The logical element may further identify, based on consumption of the MnS, a performance measurement related to usage of an edge enabling infrastructure resource for an edge application server (EAS); generate, based on the performance measurement, charging data related to the edge enabling infrastructure; and transmit an indication of the charging data to a second logical clement of the cellular system. The logical element may further identify, based on the transmitted indication of the charging data, a Charging Data Response received from the second logical element. Other embodiments may be described and/or claimed.

### CROSS REFERENCE TO RELATED APPLICATION

The present application claims priority to U.S. Provisional Patent Application No. 63/295,387, which was filed Dec. 30, 2021.

### FIELD

Various embodiments generally may relate to the field of wireless communications. For example, some embodiments may relate to charging for edge-enabling infrastructure resources.

### BACKGROUND

Various embodiments generally may relate to the field of wireless communications.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates an example of relations involved in edge computing service(s), in accordance with various embodiments.

FIG. 2 illustrates an example architecture for enabling applications—service-based representation, in accordance with various embodiments.

FIG. 3 illustrates an example of utilization of fifth generation system (5GS) networks services based on the 5GS service based architecture (SBA), in accordance with various embodiments.

FIG. 4 illustrates an example reference point representation architecture related to enabling edge applications, in accordance with various embodiments.

FIG. 5 illustrates an example converged charging architecture with a management service (MnS) producer enabled by a charging enablement function (CEF), in accordance with various embodiments.

FIGS. 6A and 6B illustrate an example of edge-enabling infrastructure resource usage charging—post-event charging (PEC), in accordance with various embodiments.

FIG. 7 schematically illustrates a wireless network in accordance with various embodiments.

FIG. 8 schematically illustrates components of a wireless network in accordance with various embodiments.

FIG. 9 is a block diagram illustrating components, according to some example embodiments, able to read instructions from a machine-readable or computer-readable medium (e.g., a non-transitory machine-readable storage medium) and perform any one or more of the methodologies discussed herein.

FIG. 10 illustrates a network in accordance with various embodiments

FIG. 11 depicts an example procedure for practicing one or more of the various embodiments discussed herein.

FIG. 12 depicts an alternative example procedure for practicing one or more of the various embodiments discussed herein.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A or B” and “A/B” mean (A), (B), or (A and B).

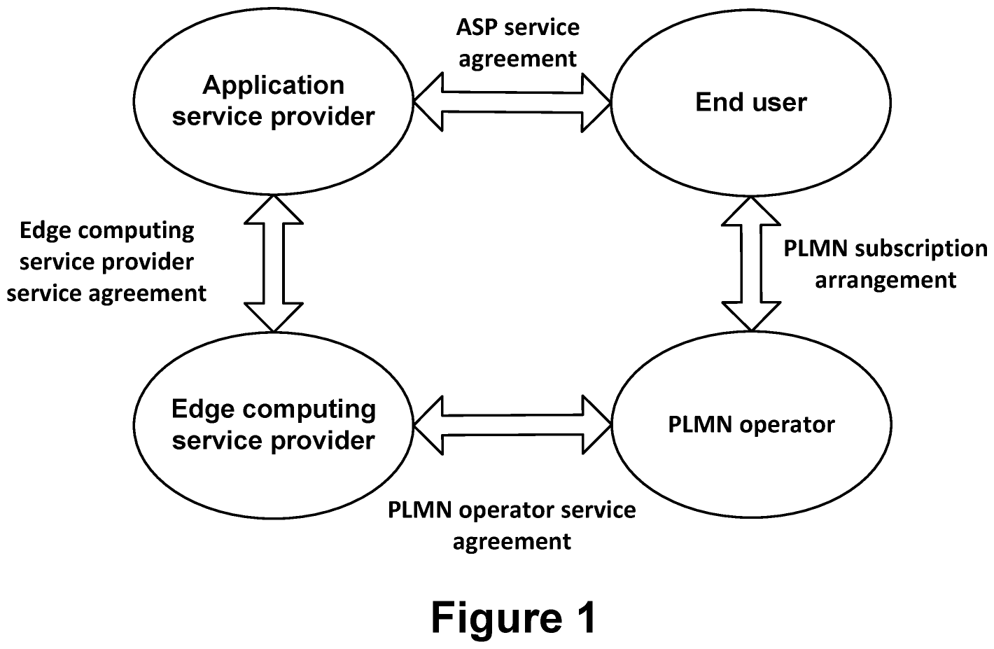

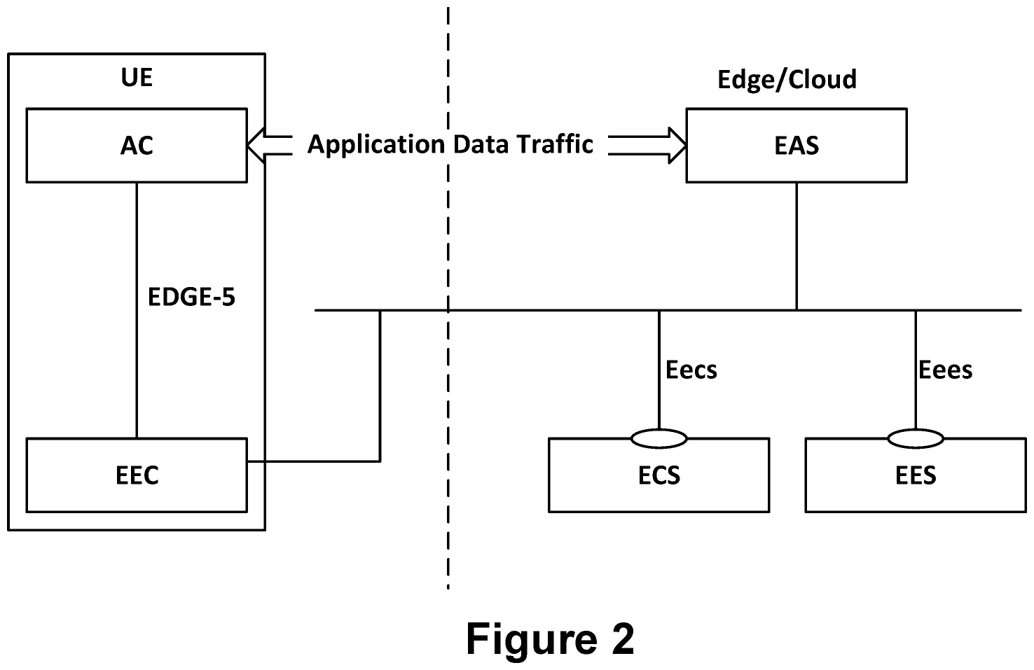

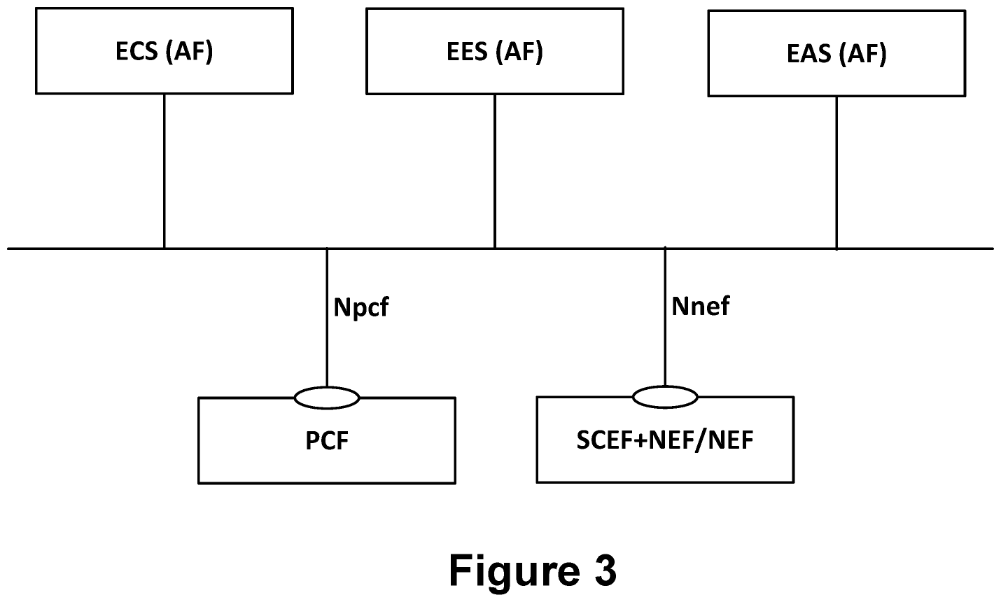

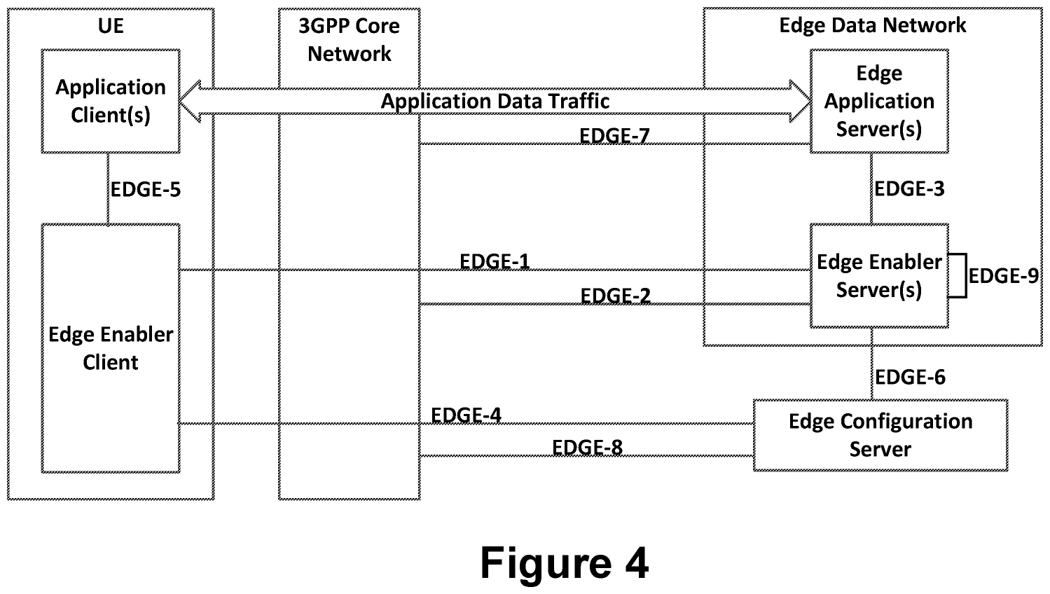

The edge computing service provider (ECSP) may provide edge enabling infrastructure resources to an application service provider (ASP) to run an Edge Application Server (EAS). The relation between ECSP and ASP may be as is depicted in FIG. 1. FIG. 2 depicts an example of a service-based representation of architecture for enabling edge applications. FIG. 3 depicts an example of a service-based representation for utilization of fifth generation system (5GS) network services. FIG. 4 depicts an example of reference point representation of architecture for edge enabling applications.

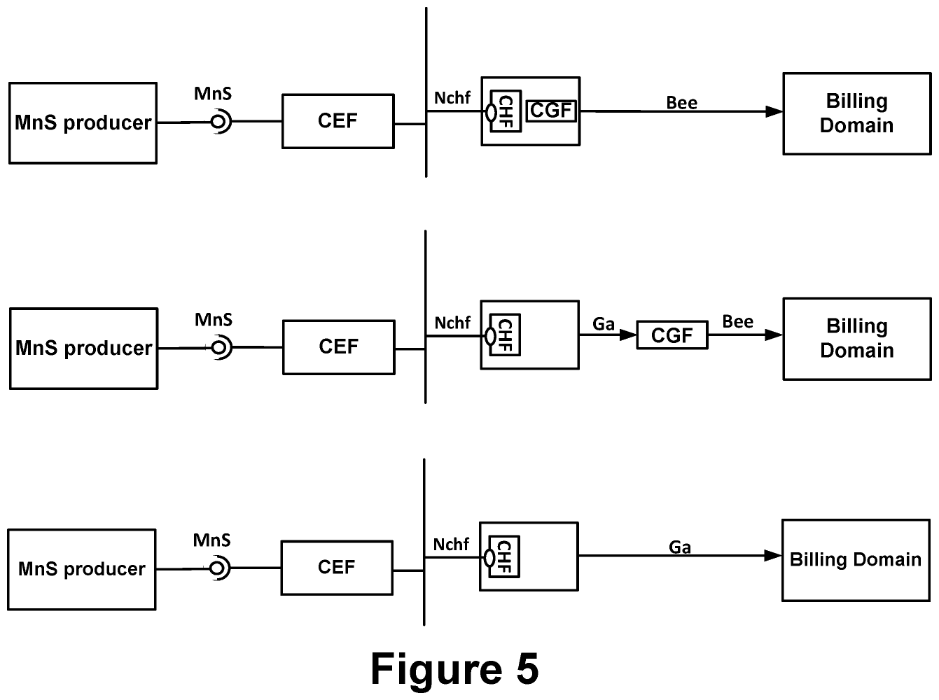

The charging for edge enabling infrastructure resources usage may be as is described in 3GPP technical report (TR) 28.815, and as may be defined in the normative technical specification based on the converged architecture described herein (for example, with respect to FIG. 5).

The TR 28.815 may describe the use cases, requirements and procedures for edge enabling infrastructure resources usage, however the detailed charging information exchanged between the relevant functions/entities to make the solution really work may not be described in legacy 3GPP TSs or TRs. Therefore, embodiments herein may define the system and information for charging for edge enabling infrastructure resources usage. Specifically, embodiments may provide solutions for charging for usage of edge enabling infrastructure resources provided by ECSP to ASP.

To define the charging principles, charging scenarios and charging information for edge enabling infrastructure resource usage, in 3GPP TS 32.257 may describe or depict the following:

### 5.1.3 Charging Principles for Edge Enabling Infrastructure Resource Usage

### 5.1.3.1 General

In the present specification, the charging is specified for the usage of edge enabling infrastructure resources in the EDN of an ECSP to run the virtualized EAS (i.e., EAS is implemented as VNF) provided by an ASP.

The charging for edge enabling infrastructure resources usage, is based on the MnS(s) for performance assurance of Edge Computing specified in TS 28.538 [12], including following resources usage for EAS:
virtual CPU usage;
virtual memory usage;
virtual disk usage;
data volumes.

### 5.1.3.2 Requirements

The following are high-level charging requirements specific to the edge enabling infrastructure resources charging:

The CEF shall be able to consume the MnS (see 28.538 [12]) to monitor the usage

of following enabling infrastructure resources that are supporting to run the virtualized EAS, and enable converged charging for the usage of these resources:
virtual CPU usage (see TS 28.552 [x]);
virtual memory usage (see TS 28.552 [x]);
virtual disk usage (see TS 28.552 [x]);
data volumes (see TS 28.552 [x]).

### 5.1.3.3 Charging Information

Charging information for edge enabling infrastructure resources usage charging is collected for each EAS by the CEF from the MnS.

The CEF collects the following charging information for converged charging of edge enabling infrastructure resources usage:
virtual CPU usage: the charging information providing the mean virtual CPU usage for the EAS, see clause 5.7.1.1.1 in TS 28.552 [x];
virtual memory usage: the charging information providing the mean virtual memory usage for the EAS, see clause 5.7.1.2.1 of TS 28.552 [x];
virtual disk usage: the charging information providing the mean virtual disk usage for the EAS, see clause 5.7.1.3.1 in TS 28.552 [x];
incoming data volume: the charging information providing the incoming data volume for the EAS, see clause 5.7.2.1 in TS 28.552 [x];
outgoing data volume: the charging information providing the outgoing data volume for the EAS, see clause 5.7.2.2 in TS 28.552 [x];
EAS: the charging information identifying the EAS which uses the edge enabling infrastructure resources;
EDN: the charging information identifying the EDN where the edge enabling infrastructure resources are allocated;
duration start time: the charging information indicating the start time of the collection period;
duration end time: the charging information indicating the end time of the collection period.

### 5.2.2 Charging Scenarios for Edge Enabling Infrastructure Resource Usage

### 5.2.2.1 Basic Principles

### 5.2.2.1.1 General

Converged charging for edge enabling infrastructure resources usage may be performed by the CEF interacting with CHF using Nchf specified in TS 32.290 [6] and TS 32.291 [7]. In order to provide the data required for the management activities outlined in TS 32.240 [1] (Credit-Control, accounting, billing, statistics etc.), the CEF shall be able to perform converged charging for each of the following:
virtual CPU usage (see VR. VCpuUsageMean in clause 5.7.1.1.1 of TS 28.552 [x]);
virtual memory usage (see VR. VMemory UsageMean in clause 5.7.1.2.1 of TS 28.552 [x]);
virtual disk usage (see VR. VDiskUsageMean in clause 5.7.1.3.1 in TS 28.552 [x]);
data volumes (see DataVolum. InBytesEAS in clause 5.7.2.1 and DataVolum. OutBytesEAS in clause 5.7.2.2 of TS 28.552 [x]).

The CEF shall request the MnS producer to create the measurement job for collecting the performance measurements on the usage of edge infrastructure resource for supporting the EAS.

Once the performance measurements on the usage of edge infrastructure resource are received or obtained, the CEF shall be able to report the corresponding charging events to CHF for CDR generation.

A detailed formal description of the converged charging parameters defined in the present document is to be found in TS 32.291 [7].

A detailed formal description of the CDR parameters defined in the present document is to be found in TS 32.298 [3].

### 5.2.2.1.2 Applicable Triggers in the CEF

When a charging event is issued towards the CHF by the CEF, it includes details of charging information, such as EAS identifier (e.g., EAS ID, see TS 23.558 [9]).

Each trigger condition (i.e., chargeable event) defined for edge enabling infrastructure resource usage charging, is specified with the associated behaviour when they are met.

The immediate report is applied to the chargeable events for edge enabling infrastructure resource usage charging, i.e., the chargeable events for which, when occurring, the current counts are closed and sent together with the charging data generated by the CEF towards the CHF in a Charging Data Request. New counts are started by the CEF.

When the CEF consumes the MnS to create measurement job, the converged charging is activated. When the CEF receives or gets the performance data report containing the usage of edge enabling infrastructure resource, the CEF invokes a Charging Data Request the CHF to report the usage as PEC.

The charging for edge enabling infrastructure resources usage can be enabled and disabled by CHF at resource type level, including virtual CPU, virtual memory, virtual disk, and data volume. The corresponding measurement job shall be created/terminated by the CEF when charging for the usage of the certain type of resources is enabled/disabled.

The chargeable events may be based on trigger thresholds and default ones can be configured in Charging Characteristics which are described in Annex A.1. The CEF is optionally provided in the Charging Data Response from CHF, with trigger thresholds which override the default ones configured in the Charging Characteristics at the CEF for the edge enabling infrastructure resource usage. They remain active until they are updated by another Charging Data Response from the CHF or the measurement job is terminated.

Table 5.2.2.1.2-1 summarizes the set of default trigger conditions and their category which shall be supported by the CEF when charging is active for the edge enabling infrastructure resource usage charging.

TABLE 5.2.2.1.2-1
Default Trigger conditions in CEF

| | | | | | |
|---|---|---|---|---|---|
| | | | | CHF | |
| | | | | allowed | Message |
| | | | CHF | to | when |
| | | | allowed to | enable | “immediate |
| Trigger | Trigger | Default | change | and | reporting” |
| Conditions | level | category | category | disable | category |

Edge enabling infrastructure resource usage reporting

| | | | | | |
|---|---|---|---|---|---|
| CEF fetches the | — | Immediate | Not | Yes | PEC: |
| performance data | | | Applicable | | Charging |
| file after | | | | | Data |
| receiving the | | | | | Request |
| notifyFileReady | | | | | [Event] |
| notification from | | | | | |
| the MnS | | | | | |
| producer, see TS | | | | | |
| 28.532 [z]; or | | | | | |
| CEF receives the | | | | | |
| performance data | | | | | |
| by the | | | | | |
| reportStreamData | | | | | |
| operation from | | | | | |
| MnS producer, | | | | | |
| see TS 28.532 [z]. | | | | | |

### 5.2.2.2 Message Flows

### 5.2.2.2.1 General

The flows in the present document specify the interactions between the MnS producer, CEF and CHF for edge enabling infrastructure resource usage converged charging.

The interaction between MnS producer and CEF is based on MnS procedures for performance assurance specified in TS 28.538 and TS 28.550 [y].

This interaction between CEF and CHF is based on Charging Data Request/Response specified in TS 32.290 [6].

5.2.2.2.2 Edge enabling infrastructure resource usage charging enabled by CEF

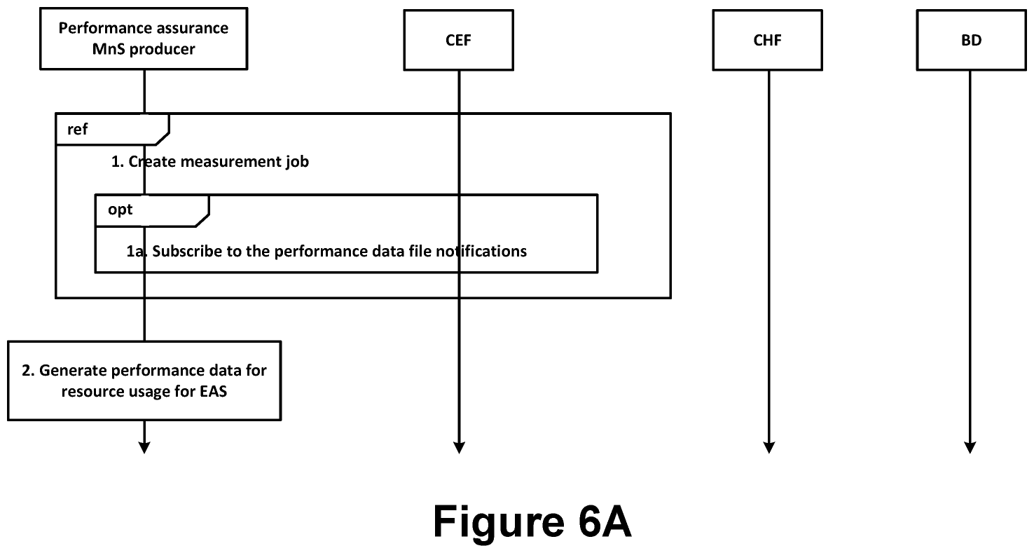

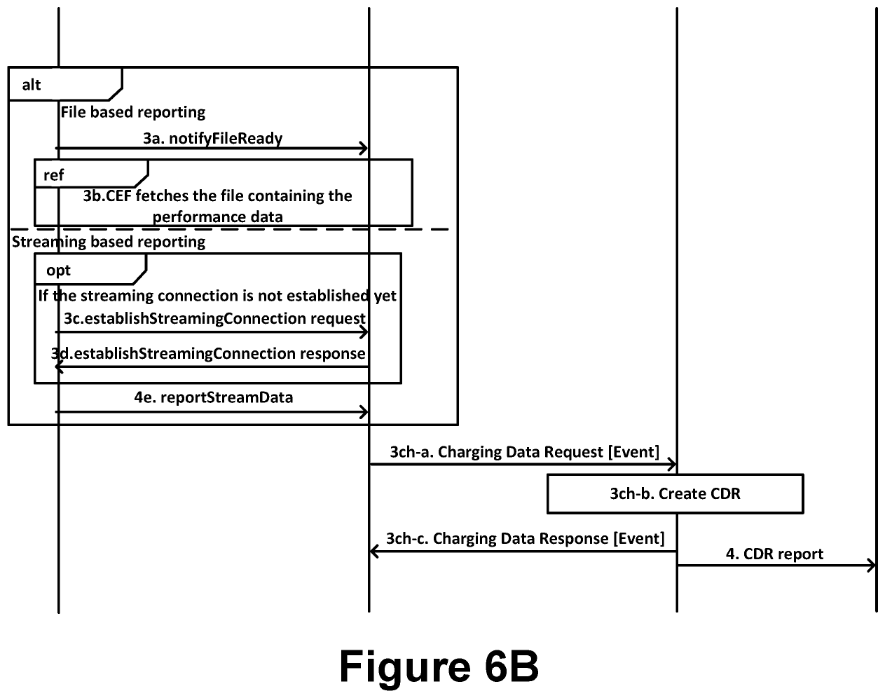

The following FIG. 5.2.2.2.2-1 [depicted herein as FIGS. 6A and 6B, with the recognition that 6B is a logical extension of FIG. 6A] describes an edge enabling infrastructure resource usage charging message flows in PEC, based on the converged charging architecture with MnS producer enabled by CEF (see clause 4.2.2).

1) Create measurement job: The CEF creates measurement job to collect the performance measurements related to Virtualized Resource (VR) usage for EAS to performance assurance MnS producer (see TS 28.538 and TS 28.550 [y]). The performance measurements can be one or more of the following:
virtual CPU usage (see VR. VCpuUsageMean in clause 5.7.1.1.1 of TS 28.552 [x]);
virtual memory usage (see VR. VMemory UsageMean in clause 5.7.1.2.1 of TS 28.552 [x]);
virtual disk usage (see VR. VDiskUsageMean in clause 5.7.1.3.1 in TS 28.552 [x]);
incoming data volume (see DataVolum.InBytesEAS in clause 5.7.2.1 of TS 28.552 [x]);
outgoing data volume (see DataVolum. OutBytesEAS in clause 5.7.2.2 of TS 28.552 [x]).

1a) Subscribe to performance data file notifications: If file reporting method is chosen for the measurement job, the CEF subscribes to the performance data file notifications, see TS 28.532 [z].

2) Generate performance measurements for resource usage for EAS: performance assurance MnS producer generates the performance measurements according to the measurement job.

3) Performance data report to CEF: the performance assurance MnS producer reports the performance data to the CEF according the reporting method selected by the CEF for the measurement job.

If the file data reporting method is selected:

3a) The performance data are reported by a notify FileReady notification (see TS 28.532 [z]);

3b) CEF fetches the file containing the performance data.

If the streaming data reporting method is selected:

3c) and 3d) The performance assurance MnS producer establishes the streaming connection with the CEF if the connection has not been established (see TS 28.532 [z]);

3e) The performance data are reported by the reportStreamData operation (see TS 28.532 [z]).

3ch-a) Charging Data Request [Event]: The CEF generates charging data for the collected resource usage and sends the charging data request for the CHF to process the related charging data for CDR generation purpose.

3ch-b) Create CDR: the CHF stores received information and creates a CDR related to the event.

3ch-c) Charging Data Response [Event]: The CHF informs the CEF on the result of the request.

4) Report the CDR to BD: The CHF reports the CDR to BD (via CGF).

### 5.2.2.3 CDR Generation

### 5.2.2.3.1 Introduction

The CHF CDRs for edge enabling infrastructure resource usage charging are generated by the CHF to collect charging information that they subsequently transfer to the Charging Gateway Function (CGF).

The following clauses describe in detail the conditions for generating the CHF CDR.

### 5.2.2.3.2 Triggers for CHF CDR

### 5.2.2.3.2.1 General

An edge enabling infrastructure resource usage charging CHF CDR is used to collect charging information related to edge enabling infrastructure resource usage chargeable events for PEC.

### 5.2.2.3.2.2 Triggers for CHF CDR Generation

A CHF CDR shall be generated by the CHF for each received Charging Data Request [Event].

### 5.2.2.4 Ga Record Transfer Flows

In Edge Computing, both fully qualified partial CDRs (FQPC) and reduced partial CDRs (RPC), as specified in TS 32.240 [2] may be supported on the Ga interface. In line with TS 32.240 [2], the support of FQPCs is mandatory, the support of RPCs is optional. For further details on the Ga protocol application refer to TS 32.295 [5].

### 5.2.2.5 Bee CDR File Transfer

In Edge Computing, both fully qualified partial CDRs (FQPC) and reduced partial CDRs (RPC), as specified in TS 32.240 [2] may be supported on the Bee interface. In line with TS 32.240 [2], the support of FQPCs is mandatory, the support of RPCs is optional. For further details on the Bee protocol application refer to TS 32.297 [4].

### 6.2 Definition of Charging Information for Edge Enabling Infrastructure Resource Usage Charging

### 6.2.1 Data Description for Edge Enabling Infrastructure Resource Usage Charging

### 6.2.1.1 Message Contents

### 6.2.1.1.1 General

The Charging Data Request and Charging Data Response are specified in TS 32.290 [6] and include charging information. The Charging Data Request can be of type [Event].

Table 6.2.1.1.1-1 describes the use of these messages for converged charging.

TABLE 6.2.1.1.1-1
Converged charging messages reference table

| Message | Source | Destination |
|---|---|---|
| Charging Data Request | CEF | CHF |
| Charging Data Response | CHF | CEF |

### 6.2.1.1.2 Charging Data Request Message

Table 6.2.1.1.2-1 illustrates the basic structure of a Charging Data Request message from the CEF as used for edge enabling infrastructure resource usage converged charging.

TABLE 6.2.1.1.2-1
Charging Data Request message contents

| | Category | |
|---|---|---|
| | for | |
| | converged | |
| Information Element | charging | Description |
| One-time Event | O_{C} | Described in TS 32.290 [6]. |
| One-time Event Type | O_{C} | Described in TS 32.290 [6]. |
| NF Consumer | M | Described in TS 32.290 [6]. |
| Identification | | |
| NF Functionality | M | Described in TS 32.290 [6]. |
| NF Name | O_{C} | Described in TS 32.290 [6]. |
| NF Address | O_{C} | Described in TS 32.290 [6]. |
| NF PLMN ID | O_{C} | Described in TS 32.290 [6]. |
| Invocation Timestamp | M | Described in TS 32.290 [6]. |
| Invocation Sequence | M | Described in TS 32.290 [6]. |
| Number | | |
| EAS ID | M | This field holds the EAS ID, |
| | | see TS 23.558 [9]. |
| EDN ID | M | This field holds the DN of |
| | | EdgeDataNetwork MOI, see |
| | | TS 28.538 [12]. |
| EAS Provider Identifier | O | The identifier of the ASP that |
| | | provides the EAS, see TS |
| | | 23.558 [9]. |
| Edge Enabling | O_{M} | This field holds the for edge |
| Infrastructure Resource | | enabling infrastructure resource |
| Usage Charging | | usage charging specific |
| Information | | information described in clause |
| | | 6.2.2.1.2. |

### 6.2.1.1.3 Charging Data Response Message

Table 6.2.1.1.3-1 illustrates the basic structure of a Charging Data Response message from the CHF as used for edge enabling infrastructure resource usage converged charging.

TABLE 66.2.1.1.3-1
Charging Data Response message contents

| | Category for | |
|---|---|---|
| | converged | |
| Information Element | charging | Description |
| Invocation Timestamp | M | Described in TS 32.290 [6] |
| Invocation Result | O_{C} | Described in TS 32.290 [6] |
| Invocation Sequence | M | Described in TS 32.290 [6] |
| Number | | |
| Triggers | O_{C} | This field is described in |
| | | TS 32.290 [6] and holds the |
| | | edge enabling infrastructure |
| | | resource usage specific |
| | | triggers described in clause |
| | | 5.2.2.1 |

### 6.2.1.2 Ga Message Contents

See clause 5.2.2.4.

### 10 6.2.1.3 CDR Description on the Bee Interface

### 6.2.1.3.1 General

This clause describes the CDR content and format generated for edge enabling infrastructure resource usage charging.

The following tables provide a brief description of each CDR parameter. The category in the tables is used according to the charging data configuration defined in clause 5.4 of TS 32.240 [2]. Full definitions of the CDR parameters, sorted by the name in alphabetical order, are provided in TS 32.298 [3].

### 6.2.1.3.2 Edge Enabling Infrastructure Resource Usage Charging CHF CDR Data

If enabled, CHF CDRs for edge enabling infrastructure resource usage charging shall be produced for each performance measurement report.

The fields of enabling infrastructure resource usage charging CHF CDR are specified in table 6.2.1.3.2-1.

TABLE 6.2.1.3.2-1
Edge enabling infrastructure resource usage charging CHF record data

| Field | Category | Description |
|---|---|---|
| Record Type | M | CHF record. |
| Recording Network | O_{M} | This field holds the name of the |
| Function ID | | recording entity, i.e. the CHF id. |
| NF Consumer | M | This field holds the information of the |
| Information | | CEF that used the charging service. |
| NF Functionality | M | This field contains the function of the |
| | | node (i.e. CEF) |
| NF Name | O_{C} | This field holds the name of the |
| | | CEF used. |
| NF Address | O_{C} | This field holds the IP Address |
| | | of the CEF used. |
| NF PLMN ID | O_{C} | This field holds the PLMN identifier |
| | | (MCC MNC) of the CEF. |
| Record Opening | M | Described in TS 32.298 [3] |
| Time | | |
| Record Sequence | C | Described in TS 32.298 [3] |
| Number | | |
| Cause for Record | M | Described in TS 32.298 [3] |
| Closing | | |
| Diagnostics | O_{M} | Described in TS 32.298 [3] |
| Local Record | O_{M} | Described in TS 32.298 [3] |
| Sequence Number | | |
| Record Extensions | O_{C} | Described in TS 32.298 [3] |
| EAS ID | M | This field holds the EAS ID, |
| | | see TS 23.558 [9]. |
| EDN ID | M | This field holds the DN of |
| | | EdgeDataNetwork MOI, |
| | | see TS 28.538 [12]. |
| EAS Provider | O | The identifier of the ASP that |
| Identifier | | provides the EAS, see TS 23.558 [9]. |
| Edge Enabling | O_{M} | This field holds the edge |
| Infrastructure | | enabling infrastructure resource |
| Resource | | usage charging specific information |
| Usage Charging | | defined in clause 6.2.2.1.2. |
| Information | | |

### 6.2.2 Edge Enabling Infrastructure Resource Usage Charging Specific Parameters

### 6.2.2.1 Definition of Edge Enabling Infrastructure Resource Usage Charging Information

### 6.2.2.1.1 General

The Charging Information parameter used for edge enabling infrastructure resource usage charging is provided in the following clauses.

### 6.2.2.1.2 Definition of Edge Enabling Infrastructure Resource Usage Specific Charging Information

Specific charging information used for edge enabling infrastructure resource usage charging is provided within the Edge Enabling Infrastructure Resource Usage Charging Information.

The detailed structure of the Edge Enabling Infrastructure Resource Usage Charging Information can be found in table 6.2.2.1.2-1.

TABLE 6.2.2.1.2-1
Structure of Edge Enabling Infrastructure Resource Usage Charging

| Information Element | Category | Description |
|---|---|---|
| Virtual CPU Usage | O_{M} | This field holds the information of |
| | | mean virtual CPU usage for the EAS, |
| | | see VR.VCpuUsageMean in clause |
| | | 5.7.1.1.1 of TS 28.552 [x]. |
| Virtual Memory | O_{M} | This field holds the information of |
| Usage | | mean virtual memory usage for |
| | | the EAS, see VR.VMemory |
| | | UsageMean in clause 5.7.1.2.1 of |
| | | TS 28.552 [x]. |
| Virtual Disk Usage | O_{M} | This field holds the information of |
| | | mean virtual disk usage for the |
| | | EAS, see VR.VDiskUsageMean in |
| | | clause 5.7.1.2.1 of TS 28.552 [x]. |
| Incoming Data | O_{M} | This field holds the information of |
| Volume | | incoming data volume for the EAS, |
| | | see DataVolum.InBytesEAS in |
| | | clause 5.7.2.1 of TS 28.552 [x]. |
| Outgoing Data | O_{M} | This field holds the information of |
| Volume | | outgoing data volume for the EAS, |
| | | see DataVolum.OutBytesEAS in |
| | | clause 5.7.2.2 of TS 28.552 [x]. |
| Duration Start Time | M | This field holds the start time of the |
| | | collection period, see TS 28.550 [y]. |
| Duration End Time | M | This field holds the end time of the |
| | | collection period, see TS 28.550 [y]. |

### 6.2.2.2 Formal Edge Enabling Infrastructure Resource Usage Charging Parameter Description

6.2.2.2.1 Edge Enabling Infrastructure Resource Usage CHF CDR parameters

Editor's note: The detailed definitions, abstract syntax and encoding of edge enabling infrastructure resource usage CHF CDRs parameters are to be specified in TS 32.298 [3].

6.2.2.2.2 Edge Enabling Infrastructure Resource Usage Resources Attributes

Editor's note: The detailed definitions of resources attributes used for edge enabling infrastructure resource usage charging are to be specified in TS 32.291 [7].

### 6.2.2.3 Detailed Message Format for Converged Charging

The following clause specifies per Operation Type the charging data that are sent by CEF for edge enabling infrastructure resource usage converged charging.

The Operation Types are listed in the following order: I (Initial)/U (Update)/T (Termination)/E (Event). Therefore, when all Operation Types are possible it is marked as IUTE. If only some Operation Types are allowed for a node, only the appropriate letters are used (i.e. IUT or E) as indicated in the table heading. The omission of an Operation Type for a particular field is marked with “-” (i.e. IU-E). Also, when an entire field is not allowed in a node the entire cell is marked as “-”.

Table 6.2.2.3-1 defines the basic structure of the supported fields in the Charging Data Request message for edge enabling infrastructure resource usage converged charging.

TABLE 6.2.3.1
Supported fields in Charging Data Request message

| | | Edge enabling |
|---|---|---|
| | | infrastructure |
| | Functionality | resource usage |
| Information Element | of CEF | charging |
| | Supported | E |
| | Operation Types | |

| | |
|---|---|
| One-time Event | E |
| One-time Event Type | E |
| NF Consumer Identification | E |
| Invocation Timestamp | E |
| Invocation Sequence Number | E |
| EAS ID | E |
| EDN ID | E |
| EAS Provider Identifier | E |
| Virtual CPU Usage | E |
| Virtual Memory Usage | E |
| Virtual Disk Usage | E |
| Incoming Data Volume | E |
| Outgoing Data Volume | E |
| Duration Start Time | E |
| Duration End Time | E |

Table 6.2.2.3-2 defines the basic structure of the supported fields in the Charging Data Response message for edge enabling infrastructure resource usage converged charging.

TABLE 6.2.2.3-2
Supported fields in Charging Data Response message

| | | Edge enabling |
|---|---|---|
| | | infrastructure |
| | Functionality | resource usage |
| Information Element | of CEF | charging |
| | Supported | E |
| | Operation Types | |

| | |
|---|---|
| Invocation Timestamp | E |
| Invocation Result | E |
| Invocation Sequence Number | E |
| Triggers | E |

### 6.2.3 Bindings for Edge Enabling Infrastructure Resource Usage Converged Charging

Editor's note: This mapping between the Information Elements, resource attributes and CHF CDR parameters for edge enabling infrastructure resource usage converged charging is to be described in TS 32.291 [7].

### Annex A (Normative)

### Charging Characteristics

### A.1 Charging Characteristics For Edge Enabling Infrastructure Resource Usage Charging

An EAS may have Charging Characteristics assigned for edge enabling infrastructure resource usage charging. Default Charging Characteristics may also be pre-provisioned on the CEF.

During interaction with CHF, the Charging Characteristics may be updated by Charging Data Response from CHF, it may override the CEF pre-provisioned Charging Characteristics.

The Charging Characteristics parameter consists of a string of 16 bits designated as Behaviours (B), freely defined by Operators, as shown in TS 32.298 [3]. Each bit corresponds to a specific charging behaviour, and pointed when bit is set to “1” value.

A charging behaviour is defined as an association to a specific usage design:

One usage may consist of a set of trigger profiles associated to the edge enabling infrastructure resource usage in converged charging as described in the Table A.1-1 example:

TABLE A.1-1
Example of Charging Characteristics behaviours for CEF

| | edge enabling infrastructure resource usage charging | | | | | | | |
|---|---|---|---|---|---|---|---|---|
| | Primary | | | | | | | |
| | and | | | | | | | |
| | Secondary | | | | | | | |
| Behaviour | CHF | Resource usage | | Duration | | Usage | | |
| index | addresses | type | Active | period | | threshold | | . . . |
| 0 | URI 1 | Virtual CPU | Yes | 5 | min | 70% | | . . . |
| | URI 2 | usage | | | | | | |
| 1 | URI 1 | Virtual memory | No | 5 | min | 80% | | . . . |
| | URI 2 | usage | | | | | | |
| 2 | URI 1 | Virtual disk | Yes | 10 | min | 70% | | . . . |
| | URI 2 | usage | | | | | | |
| 3 | URI 1 | Incoming data | Yes | 5 | min | 5 | MB | . . . |
| | URI 2 | volume | | | | | | |
| 4 | URI 1 | Outgoing data | Yes | 5 | min | 20 | MB | . . . |

| | | | | | | |
|---|---|---|---|---|---|---|
| | URI 2 | volume | | | | |
| . . . | . . . | . . . | . . . | . . . | . . . | . . . |

Associated to the behaviour, the following may also be configured:
the CHF addresses to be used by the CEF.

### Abbreviations

For the purposes of the present document, the abbreviations given in 3GPP TR 21.905 [1], TS 23.501 [8], TS 23.558 [9], TS 23.548 [10] and the following apply. An abbreviation defined in the present document takes precedence over the definition of the same abbreviation, if any, in 3GPP TR 21.905 [1], TS 23.501 [8], TS 23.558 [9] and TS 23.548 [10].

| | |
|---|---|
| ASP | Application Service Provider |
| ECSP | Edge Computing Service Provider |
| MNO | Mobile Network Operator |
| CEF | Charging Enablement Function |
| CHF | Charging Function |
| EAS | Edge Application Server |
| EES | Edge Enabler Server |
| MnS | Management Service |
| MOI | Managed Object Instance |

### REFERENCES

[1] 3GPP TR 21.905: “Vocabulary for 3GPP Specifications”.

[2] 3GPP TS 32.240: “Telecommunication management; Charging management; Charging architecture and principles”.

[3] 3GPP TS 32.298: “Telecommunication management; Charging management; Charging Data Record (CDR) parameter description”.

[4] 3GPP TS 32.297: “Telecommunication management; Charging management; Charging Data Record (CDR) file format and transfer”.

[5] 3GPP TS 32.295: “Telecommunication management; Charging management; Charging Data Record (CDR) transfer”.

[6] 3GPP TS 32.290: “Telecommunication management; Charging management; 5G system; Services, operations and procedures of charging using Service Based Interface (SBI)”.

[7] 3GPP TS 32.291: “Telecommunication management; Charging management; 5G system; Charging service, stage 3”.

[8] 3GPP TS 23.501: “System architecture for the 5G System (5GS); Stage 2”.

[9] 3GPP TS 23.558: “Architecture for enabling Edge Applications”.

[10] 3GPP TS 23.548 “5G System Enhancements for Edge Computing; Stage 2”.

[11] 3GPP TS 32.255: “Telecommunication management; Charging management; 5G Data connectivity domain charging; stage 2”.

[12] 3GPP TS 28.538: “Management and orchestration; Edge Computing Management”.

[x] 3GPP TS 28.552: “Management and orchestration; 5G performance measurements”.

[y] 3GPP TS 28.550: “Management and orchestration; Performance assurance”.

[z] 3GPP TS 28.532: “Management and orchestration; Generic management services”.

### Systems and Implementations

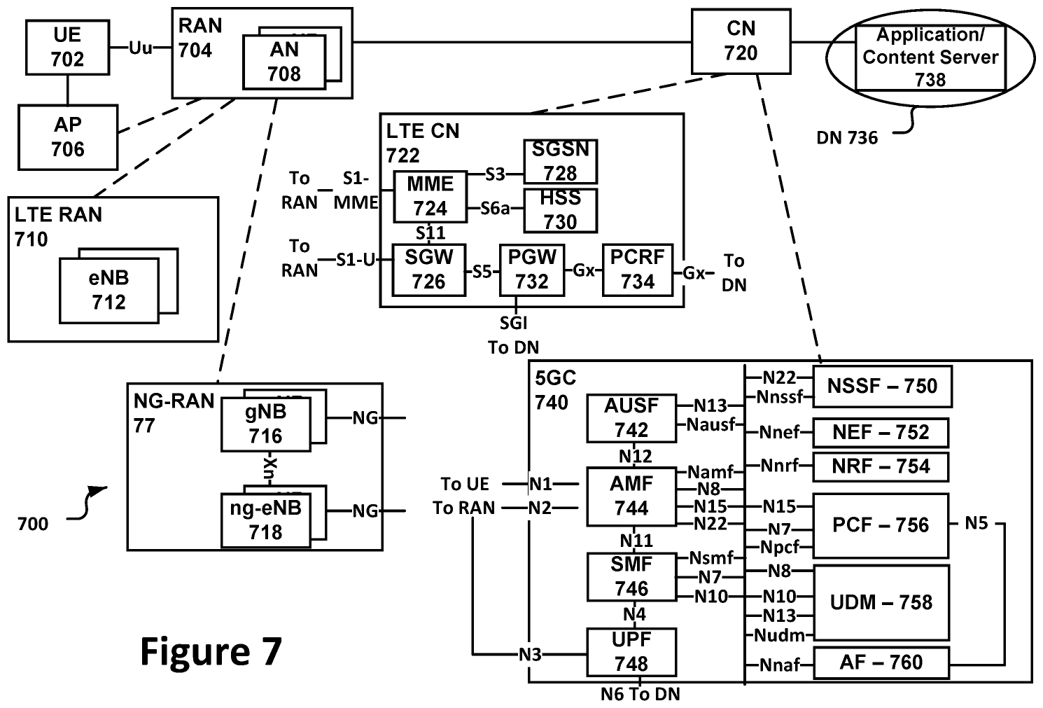

FIGS. 7-10 illustrate various systems, devices, and components that may implement aspects of disclosed embodiments.

FIG. 7 illustrates a network 700 in accordance with various embodiments. The network 700 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 700 may include a UE 702, which may include any mobile or non-mobile computing device designed to communicate with a RAN 704 via an over-the-air connection. The UE 702 may be communicatively coupled with the RAN 704 by a Uu interface. The UE 702 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 700 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 702 may additionally communicate with an AP 706 via an over-the-air connection. The AP 706 may manage a WLAN connection, which may serve to offload some/all network traffic from the RAN 704. The connection between the UE 702 and the AP 706 may be consistent with any IEEE 802.11 protocol, wherein the AP 706 could be a wireless fidelity (Wi-Fi®) router. In some embodiments, the UE 702, RAN 704, and AP 706 may utilize cellular-WLAN aggregation (for example, LWA/LWIP). Cellular-WLAN aggregation may involve the UE 702 being configured by the RAN 704 to utilize both cellular radio resources and WLAN resources.

The RAN 704 may include one or more access nodes, for example, AN 708. AN 708 may terminate air-interface protocols for the UE 702 by providing access stratum protocols including RRC, PDCP, RLC, MAC, and L1 protocols. In this manner, the AN 708 may enable data/voice connectivity between CN 720 and the UE 702. In some embodiments, the AN 708 may be implemented in a discrete device or as one or more software entities running on server computers as part of, for example, a virtual network, which may be referred to as a CRAN or virtual baseband unit pool. The AN 708 be referred to as a BS, gNB, RAN node, eNB, ng-eNB, NodeB, RSU, TRxP, TRP, etc. The AN 708 may be a macrocell base station or a low power base station for providing femtocells, picocells or other like cells having smaller coverage areas, smaller user capacity, or higher bandwidth compared to macrocells.

In embodiments in which the RAN 704 includes a plurality of ANs, they may be coupled with one another via an X2 interface (if the RAN 704 is an LTE RAN) or an Xn interface (if the RAN 704 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 704 may each manage one or more cells, cell groups, component carriers, etc. to provide the UE 702 with an air interface for network access. The UE 702 may be simultaneously connected with a plurality of cells provided by the same or different ANs of the RAN 704. For example, the UE 702 and RAN 704 may use carrier aggregation to allow the UE 702 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 704 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 702 or AN 708 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance. traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 704 may be an LTE RAN 710 with eNBs, for example, eNB 712. The LTE RAN 710 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHZ bands.

In some embodiments, the RAN 704 may be an NG-RAN 714 with gNBs, for example, gNB 716, or ng-eNBs, for example, ng-eNB 718. The gNB 716 may connect with 5G-enabled UEs using a 5G NR interface. The gNB 716 may connect with a 5G core through an NG interface, which may include an N2 interface or an N3 interface. The ng-eNB 718 may also connect with the 5G core through an NG interface, but may connect with a UE via an LTE air interface. The gNB 716 and the ng-eNB 718 may connect with each other over an Xn interface.

In some embodiments, the NG interface may be split into two parts, an NG user plane (NG-U) interface, which carries traffic data between the nodes of the NG-RAN 714 and a UPF 748 (e.g., N3 interface), and an NG control plane (NG-C) interface, which is a signaling interface between the nodes of the NG-RAN 714 and an AMF 744 (e.g., N2 interface).

The NG-RAN 714 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHZ. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 702 can be configured with multiple BWPs where each BWP configuration has a different SCS. When a BWP change is indicated to the UE 702, the SCS of the transmission is changed as well. Another use case example of BWP is related to power saving. In particular, multiple BWPs can be configured for the UE 702 with different amount of frequency resources (for example, PRBs) to support data transmission under different traffic loading scenarios. A BWP containing a smaller number of PRBs can be used for data transmission with small traffic load while allowing power saving at the UE 702 and in some cases at the gNB 716. A BWP containing a larger number of PRBs can be used for scenarios with higher traffic load.

The RAN 704 is communicatively coupled to CN 720 that includes network elements to provide various functions to support data and telecommunications services to customers/subscribers (for example, users of UE 702). The components of the CN 720 may be implemented in one physical node or separate physical nodes. In some embodiments. NFV may be utilized to virtualize any or all of the functions provided by the network elements of the CN 720 onto physical compute/storage resources in servers, switches, etc. A logical instantiation of the CN 720 may be referred to as a network slice, and a logical instantiation of a portion of the CN 720 may be referred to as a network sub-slice.

In some embodiments, the CN 720 may be an LTE CN 722, which may also be referred to as an EPC. The LTE CN 722 may include MME 724, SGW 726, SGSN 728, HSS 730, PGW 732, and PCRF 734 coupled with one another over interfaces (or “reference points”) as shown. Functions of the elements of the LTE CN 722 may be briefly introduced as follows.

The MME 724 may implement mobility management functions to track a current location of the UE 702 to facilitate paging, bearer activation/deactivation, handovers, gateway selection, authentication, etc.

The SGW 726 may terminate an S1 interface toward the RAN and route data packets between the RAN and the LTE CN 722. The SGW 726 may be a local mobility anchor point for inter-RAN node handovers and also may provide an anchor for inter-3GPP mobility. Other responsibilities may include lawful intercept, charging, and some policy enforcement.

The SGSN 728 may track a location of the UE 702 and perform security functions and access control. In addition, the SGSN 728 may perform inter-EPC node signaling for mobility between different RAT networks; PDN and S-GW selection as specified by MME 724; MME selection for handovers; etc. The S3 reference point between the MME 724 and the SGSN 728 may enable user and bearer information exchange for inter-3GPP access network mobility in idle/active states.

The HSS 730 may include a database for network users, including subscription-related information to support the network entities' handling of communication sessions. The HSS 730 can provide support for routing/roaming, authentication, authorization, naming/addressing resolution, location dependencies, etc. An S6a reference point between the HSS 730 and the MME 724 may enable transfer of subscription and authentication data for authenticating/authorizing user access to the LTE CN 720.

The PGW 732 may terminate an SGi interface toward a data network (DN) 736 that may include an application/content server 738. The PGW 732 may route data packets between the LTE CN 722 and the data network 736. The PGW 732 may be coupled with the SGW 726 by an S5 reference point to facilitate user plane tunneling and tunnel management. The PGW 732 may further include a node for policy enforcement and charging data collection (for example, PCEF). Additionally, the SGi reference point between the PGW 732 and the data network 736 may be an operator external public, a private PDN, or an intra-operator packet data network, for example, for provision of IMS services. The PGW 732 may be coupled with a PCRF 734 via a Gx reference point.

The PCRF 734 is the policy and charging control element of the LTE CN 722. The PCRF 734 may be communicatively coupled to the app/content server 738 to determine appropriate QoS and charging parameters for service flows. The PCRF 732 may provision associated rules into a PCEF (via Gx reference point) with appropriate TFT and QCI.

In some embodiments, the CN 720 may be a 5GC 740. The 5GC 740 may include an AUSF 742, AMF 744, SMF 746, UPF 748, NSSF 750, NEF 752, NRF 754, PCF 756, UDM 758, and AF 760 coupled with one another over interfaces (or “reference points”) as shown. Functions of the elements of the 5GC 740 may be briefly introduced as follows.

The AUSF 742 may store data for authentication of UE 702 and handle authentication-related functionality. The AUSF 742 may facilitate a common authentication framework for various access types. In addition to communicating with other elements of the 5GC 740 over reference points as shown, the AUSF 742 may exhibit an Nausf service-based interface.

The AMF 744 may allow other functions of the 5GC 740 to communicate with the UE 702 and the RAN 704 and to subscribe to notifications about mobility events with respect to the UE 702. The AMF 744 may be responsible for registration management (for example, for registering UE 702), connection management, reachability management, mobility management, lawful interception of AMF-related events, and access authentication and authorization. The AMF 744 may provide transport for SM messages between the UE 702 and the SMF 746, and act as a transparent proxy for routing SM messages. AMF 744 may also provide transport for SMS messages between UE 702 and an SMSF. AMF 744 may interact with the AUSF 742 and the UE 702 to perform various security anchor and context management functions. Furthermore. AMF 744 may be a termination point of a RAN CP interface, which may include or be an N2 reference point between the RAN 704 and the AMF 744; and the AMF 744 may be a termination point of NAS (N1) signaling, and perform NAS ciphering and integrity protection. AMF 744 may also support NAS signaling with the UE 702 over an N3 IWF interface.

The SMF 746 may be responsible for SM (for example, session establishment, tunnel management between UPF 748 and AN 708); UE IP address allocation and management (including optional authorization); selection and control of UP function; configuring traffic steering at UPF 748 to route traffic to proper destination; termination of interfaces toward policy control functions; controlling part of policy enforcement, charging, and QoS; lawful intercept (for SM events and interface to L1 system); termination of SM parts of NAS messages; downlink data notification; initiating AN specific SM information, sent via AMF 744 over N2 to AN 708; and determining SSC mode of a session. SM may refer to management of a PDU session, and a PDU session or “session” may refer to a PDU connectivity service that provides or enables the exchange of PDUs between the UE 702 and the data network 736.

The UPF 748 may act as an anchor point for intra-RAT and inter-RAT mobility, an external PDU session point of interconnect to data network 736, and a branching point to support multi-homed PDU session. The UPF 748 may also perform packet routing and forwarding. perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 748 may include an uplink classifier to support routing traffic flows to a data network.

The NSSF 750 may select a set of network slice instances serving the UE 702. The NSSF 750 may also determine allowed NSSAI and the mapping to the subscribed S-NSSAIs, if needed. The NSSF 750 may also determine the AMF set to be used to serve the UE 702, or a list of candidate AMFs based on a suitable configuration and possibly by querying the NRF 754. The selection of a set of network slice instances for the UE 702 may be triggered by the AMF 744 with which the UE 702 is registered by interacting with the NSSF 750, which may lead to a change of AMF. The NSSF 750 may interact with the AMF 744 via an N22 reference point; and may communicate with another NSSF in a visited network via an N31 reference point (not shown). Additionally, the NSSF 750 may exhibit an Nnssf service-based interface.

The NEF 752 may securely expose services and capabilities provided by 3GPP network functions for third party, internal exposure/re-exposure, AFs (e.g., AF 760), edge computing or fog computing systems, etc. In such embodiments, the NEF 752 may authenticate, authorize, or throttle the AFs. NEF 752 may also translate information exchanged with the AF 760 and information exchanged with internal network functions. For example, the NEF 752 may translate between an AF-Service-Identifier and an internal 5GC information. NEF 752 may also receive information from other NFs based on exposed capabilities of other NFs. This information may be stored at the NEF 752 as structured data, or at a data storage NF using standardized interfaces. The stored information can then be re-exposed by the NEF 752 to other NFs and AFs, or used for other purposes such as analytics. Additionally, the NEF 752 may exhibit an Nnef service-based interface.

The NRF 754 may support service discovery functions, receive NF discovery requests from NF instances, and provide the information of the discovered NF instances to the NF instances. NRF 754 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 754 may exhibit the Nnrf service-based interface.

The PCF 756 may provide policy rules to control plane functions to enforce them, and may also support unified policy framework to govern network behavior. The PCF 756 may also implement a front end to access subscription information relevant for policy decisions in a UDR of the UDM 758. In addition to communicating with functions over reference points as shown. the PCF 756 exhibit an Npcf service-based interface.

The UDM 758 may handle subscription-related information to support the network entities' handling of communication sessions, and may store subscription data of UE 702. For example, subscription data may be communicated via an N8 reference point between the UDM 758 and the AMF 744. The UDM 758 may include two parts, an application front end and a UDR. The UDR may store subscription data and policy data for the UDM 758 and the PCF 756, and/or structured data for exposure and application data (including PFDs for application detection, application request information for multiple UEs 702) for the NEF 752. The Nudr service-based interface may be exhibited by the UDR 221 to allow the UDM 758, PCF 756, and NEF 752 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 758 may exhibit the Nudm service-based interface.

The AF 760 may provide application influence on traffic routing, provide access to NEF, and interact with the policy framework for policy control.

In some embodiments, the 5GC 740 may enable edge computing by selecting operator/3^{rd} party services to be geographically close to a point that the UE 702 is attached to the network. This may reduce latency and load on the network. To provide edge-computing implementations. the 5GC 740 may select a UPF 748 close to the UE 702 and execute traffic steering from the UPF 748 to data network 736 via the N6 interface. This may be based on the UE subscription data, UE location, and information provided by the AF 760. In this way, the AF 760 may influence UPF (re)selection and traffic routing. Based on operator deployment, when AF 760 is considered to be a trusted entity, the network operator may permit AF 760 to interact directly with relevant NFs. Additionally, the AF 760 may exhibit an Naf service-based interface.

The data network 736 may represent various network operator services. Internet access, or third party services that may be provided by one or more servers including, for example, application/content server 738.

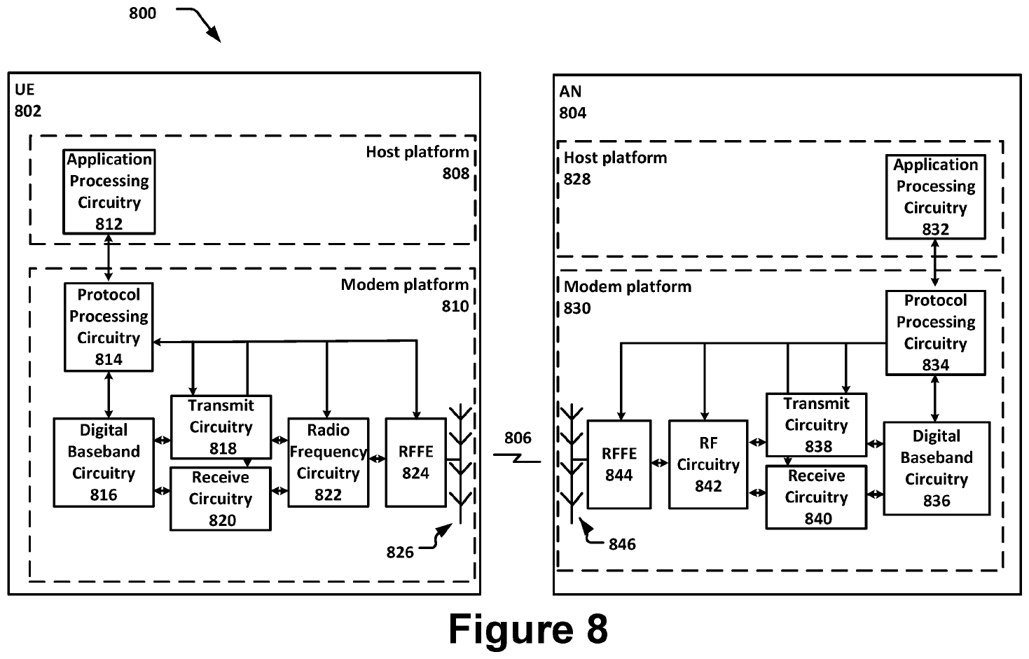

FIG. 8 schematically illustrates a wireless network 800 in accordance with various embodiments. The wireless network 800 may include a UE 802 in wireless communication with an AN 804. The UE 802 and AN 804 may be similar to, and substantially interchangeable with, like-named components described elsewhere herein.

The UE 802 may be communicatively coupled with the AN 804 via connection 806. The connection 806 is illustrated as an air interface to enable communicative coupling, and can be consistent with cellular communications protocols such as an LTE protocol or a 5G NR protocol operating at mmWave or sub-6 GHZ frequencies.

The UE 802 may include a host platform 808 coupled with a modem platform 810. The host platform 808 may include application processing circuitry 812, which may be coupled with protocol processing circuitry 814 of the modem platform 810. The application processing circuitry 812 may run various applications for the UE 802 that source/sink application data. The application processing circuitry 812 may further implement one or more layer operations to transmit/receive application data to/from a data network. These layer operations may include transport (for example UDP) and Internet (for example, IP) operations

The protocol processing circuitry 814 may implement one or more of layer operations to facilitate transmission or reception of data over the connection 806. The layer operations implemented by the protocol processing circuitry 814 may include, for example, MAC, RLC, PDCP, RRC and NAS operations.

The modem platform 810 may further include digital baseband circuitry 816 that may implement one or more layer operations that are “below” layer operations performed by the protocol processing circuitry 814 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 810 may further include transmit circuitry 818, receive circuitry 820, RF circuitry 822, and RF front end (RFFE) 824, which may include or connect to one or more antenna panels 826. Briefly, the transmit circuitry 818 may include a digital-to-analog converter, mixer, intermediate frequency (IF) components, etc.; the receive circuitry 820 may include an analog-to-digital converter, mixer, IF components, etc.; the RF circuitry 822 may include a low-noise amplifier, a power amplifier, power tracking components, etc.; RFFE 824 may include filters (for example, surface/bulk acoustic wave filters), switches, antenna tuners, beamforming components (for example, phase-array antenna components), etc. The selection and arrangement of the components of the transmit circuitry 818, receive circuitry 820, RF circuitry 822, RFFE 824, and antenna panels 826 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 814 may include one or more instances of control circuitry (not shown) to provide control functions for the transmit/receive components.

A UE reception may be established by and via the antenna panels 826, RFFE 824, RF circuitry 822, receive circuitry 820, digital baseband circuitry 816, and protocol processing circuitry 814. In some embodiments, the antenna panels 826 may receive a transmission from the AN 804 by receive-beamforming signals received by a plurality of antennas/antenna elements of the one or more antenna panels 826.

A UE transmission may be established by and via the protocol processing circuitry 814, digital baseband circuitry 816, transmit circuitry 818, RF circuitry 822, RFFE 824, and antenna panels 826. In some embodiments, the transmit components of the UE 804 may apply a spatial filter to the data to be transmitted to form a transmit beam emitted by the antenna elements of the antenna panels 826.

Similar to the UE 802, the AN 804 may include a host platform 828 coupled with a modem platform 830. The host platform 828 may include application processing circuitry 832 coupled with protocol processing circuitry 834 of the modem platform 830. The modem platform may further include digital baseband circuitry 836, transmit circuitry 838, receive circuitry 840, RF circuitry 842, RFFE circuitry 844, and antenna panels 846. The components of the AN 804 may be similar to and substantially interchangeable with like-named components of the UE 802. In addition to performing data transmission/reception as described above, the components of the AN 808 may perform various logical functions that include, for example, RNC functions such as radio bearer management, uplink and downlink dynamic radio resource management, and data packet scheduling.

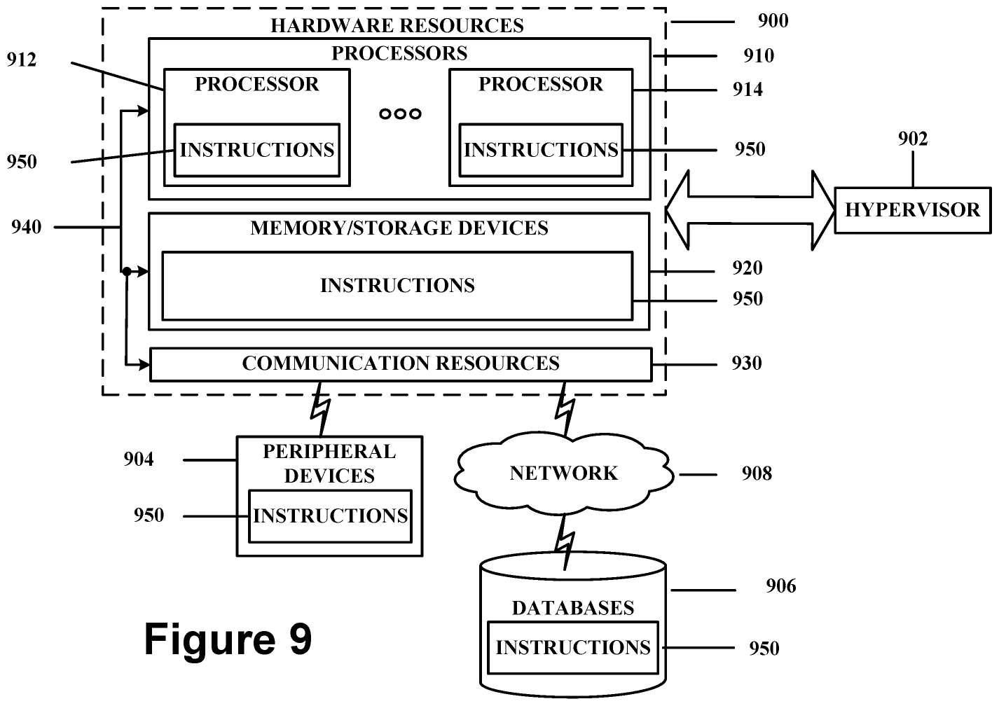

FIG. 9) is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 9 shows a diagrammatic representation of hardware resources 900 including one or more processors (or processor cores) 910, one or more memory/storage devices 920, and one or more communication resources 930, each of which may be communicatively coupled via a bus 940 or other interface circuitry. For embodiments where node virtualization (e.g., NFV) is utilized, a hypervisor 902 may be executed to provide an execution environment for one or more network slices/sub-slices to utilize the hardware resources 900.

The processors 910 may include, for example, a processor 912 and a processor 914. The processors 910 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 920 may include main memory, disk storage, or any suitable combination thereof. The memory/storage devices 920 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 930 may include interconnection or network interface controllers, components, or other suitable devices to communicate with one or more peripheral devices 904 or one or more databases 906 or other network elements via a network 908. For example, the communication resources 930 may include wired communication components (e.g., for coupling via USB, Ethernet, etc.), cellular communication components, NFC components, Bluetooth® (or Bluetooth® Low Energy) components, Wi-Fi® components, and other communication components.

Instructions 950 may comprise software, a program, an application, an applet, an app, or other executable code for causing at least any of the processors 910 to perform any one or more of the methodologies discussed herein. The instructions 950 may reside, completely or partially, within at least one of the processors 910 (e.g., within the processor's cache memory), the memory/storage devices 920, or any suitable combination thereof. Furthermore, any portion of the instructions 950 may be transferred to the hardware resources 900 from any combination of the peripheral devices 904 or the databases 906. Accordingly, the memory of processors 910, the memory/storage devices 920, the peripheral devices 904, and the databases 906 are examples of computer-readable and machine-readable media.

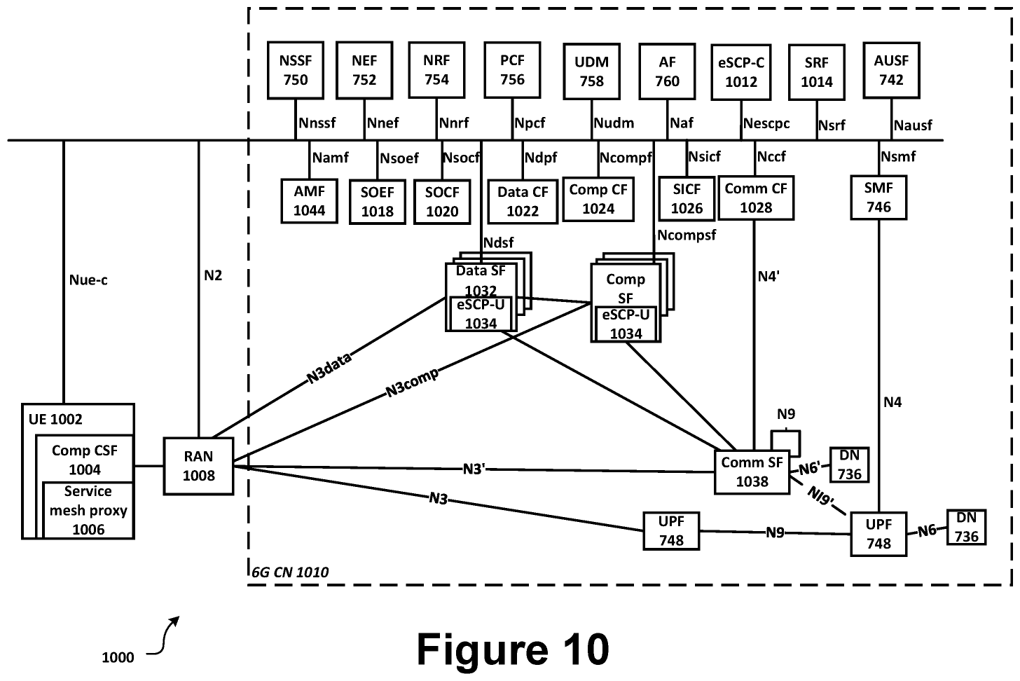

FIG. 10 illustrates a network 1000 in accordance with various embodiments. The network 1000 may operate in a matter consistent with 3GPP technical specifications or technical reports for 6G systems. In some embodiments, the network 1000 may operate concurrently with network 700. For example, in some embodiments, the network 1000 may share one or more frequency or bandwidth resources with network 700. As one specific example, a UE (e.g., UE 1002) may be configured to operate in both network 1000 and network 700. Such configuration may be based on a UE including circuitry configured for communication with frequency and bandwidth resources of both networks 700 and 1000. In general, several elements of network 1000 may share one or more characteristics with elements of network 700. For the sake of brevity and clarity, such elements may not be repeated in the description of network 1000.

The network 1000 may include a UE 1002, which may include any mobile or non-mobile computing device designed to communicate with a RAN 1008 via an over-the-air connection. The UE 1002 may be similar to, for example, UE 702. The UE 1002 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

Although not specifically shown in FIG. 10, in some embodiments the network 1000 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc. Similarly, although not specifically shown in FIG. 10, the UE 1002 may be communicatively coupled with an AP such as AP 706 as described with respect to FIG. 7. Additionally, although not specifically shown in FIG. 10. in some embodiments the RAN 1008 may include one or more ANss such as AN 708 as described with respect to FIG. 7. The RAN 1008 and/or the AN of the RAN 1008 may be referred to as a base station (BS), a RAN node, or using some other term or name.

The UE 1002 and the RAN 1008 may be configured to communicate via an air interface that may be referred to as a sixth generation (6G) air interface. The 6G air interface may include one or more features such as communication in a terahertz (THz) or sub-THz bandwidth, or joint communication and sensing. As used herein, the term “joint communication and sensing” may refer to a system that allows for wireless communication as well as radar-based sensing via various types of multiplexing. As used herein. THz or sub-THz bandwidths may refer to communication in the 80 GHZ and above frequency ranges. Such frequency ranges may additionally or alternatively be referred to as “millimeter wave” or “mmWave” frequency ranges.

The RAN 1008 may allow for communication between the UE 1002 and a 6G core network (CN) 1010. Specifically, the RAN 1008 may facilitate the transmission and reception of data between the UE 1002 and the 6G CN 1010. The 6G CN 1010 may include various functions such as NSSF 750, NEF 752, NRF 754, PCF 756, UDM 758, AF 760, SMF 746, and AUSF 742. The 6G CN 1010 may additional include UPF 748 and DN 736 as shown in FIG. 10.

Additionally, the RAN 1008 may include various additional functions that are in addition to, or alternative to, functions of a legacy cellular system such as a 4G or 5G system. Two such functions may include a Compute Control Function (Comp CF) 1024 and a Compute Service Function (Comp SF) 1036. The Comp CF 1024 and the Comp SF 1036 may be parts or functions of the Computing Service Plane. Comp CF 1024 may be a control plane function that provides functionalities such as management of the Comp SF 1036, computing task context generation and management (e.g., create, read, modify, delete), interaction with the underlaying computing infrastructure for computing resource management, etc. Comp SF 1036 may be a user plane function that serves as the gateway to interface computing service users (such as UE 1002) and computing nodes behind a Comp SF instance. Some functionalities of the Comp SF 1036 may include: parse computing service data received from users to compute tasks executable by computing nodes; hold service mesh ingress gateway or service API gateway; service and charging policies enforcement; performance monitoring and telemetry collection, etc. In some embodiments, a Comp SF 1036 instance may serve as the user plane gateway for a cluster of computing nodes. A Comp CF 1024 instance may control one or more Comp SF 1036 instances.

Two other such functions may include a Communication Control Function (Comm CF) 1028 and a Communication Service Function (Comm SF) 1038, which may be parts of the Communication Service Plane. The Comm CF 1028 may be the control plane function for managing the Comm SF 1038, communication sessions creation/configuration/releasing, and managing communication session context. The Comm SF 1038 may be a user plane function for data transport. Comm CF 1028 and Comm SF 1038 may be considered as upgrades of SMF 746 and UPF 748, which were described with respect to a 5G system in FIG. 7. The upgrades provided by the Comm CF 1028 and the Comm SF 1038 may enable service-aware transport. For legacy (e.g., 4G or 5G) data transport. SMF 746 and UPF 748 may still be used.

Two other such functions may include a Data Control Function (Data CF) 1022 and Data Service Function (Data SF) 1032 may be parts of the Data Service Plane. Data CF 1022 may be a control plane function and provides functionalities such as Data SF 1032 management. Data service creation/configuration/releasing. Data service context management, etc. Data SF 1032 may be a user plane function and serve as the gateway between data service users (such as UE 1002 and the various functions of the 6G CN 1010) and data service endpoints behind the gateway. Specific functionalities may include: parse data service user data and forward to corresponding data service endpoints, generate charging data, report data service status.

Another such function may be the Service Orchestration and Chaining Function (SOCF) 1020, which may discover, orchestrate and chain up communication/computing/data services provided by functions in the network. Upon receiving service requests from users. SOCF 1020 may interact with one or more of Comp CF 1024, Comm CF 1028, and Data CF 1022 to identify Comp SF 1036,. Comm SF 1038, and Data SF 1032 instances, configure service resources, and generate the service chain, which could contain multiple Comp SF 1036, Comm SF 1038, and Data SF 1032 instances and their associated computing endpoints. Workload processing and data movement may then be conducted within the generated service chain. The SOCF 1020 may also responsible for maintaining, updating, and releasing a created service chain.

Another such function may be the service registration function (SRF) 1014, which may act as a registry for system services provided in the user plane such as services provided by service endpoints behind Comp SF 1036 and Data SF 1032 gateways and services provided by the UE 1002. The SRF 1014 may be considered a counterpart of NRF 754, which may act as the registry for network functions.

Other such functions may include an evolved service communication proxy (eSCP) and service infrastructure control function (SICF) 1026, which may provide service communication infrastructure for control plane services and user plane services. The eSCP may be related to the service communication proxy (SCP) of 5G with user plane service communication proxy capabilities being added. The eSCP is therefore expressed in two parts: eCSP-C 1012 and eSCP-U 1034, for control plane service communication proxy and user plane service communication proxy, respectively. The SICF 1026 may control and configure eCSP instances in terms of service traffic routing policies, access rules, load balancing configurations, performance monitoring, etc.

Another such function is the AMF 1044. The AMF 1044 may be similar to 744, but with additional functionality. Specifically, the AMF 1044 may include potential functional repartition. such as move the message forwarding functionality from the AMF 1044 to the RAN 1008.

Another such function is the service orchestration exposure function (SOEF) 1018. The SOEF may be configured to expose service orchestration and chaining services to external users such as applications.

The UE 1002 may include an additional function that is referred to as a computing client service function (comp CSF) 1004. The comp CSF 1004 may have both the control plane functionalities and user plane functionalities, and may interact with corresponding network side functions such as SOCF 1020, Comp CF 1024, Comp SF 1036, Data CF 1022, and/or Data SF 1032 for service discovery, request/response, compute task workload exchange, etc. The Comp CSF 1004 may also work with network side functions to decide on whether a computing task should be run on the UE 1002, the RAN 1008, and/or an element of the 6G CN 1010.

The UE 1002 and/or the Comp CSF 1004 may include a service mesh proxy 1006. The service mesh proxy 1006 may act as a proxy for service-to-service communication in the user plane. Capabilities of the service mesh proxy 1006 may include one or more of addressing, security, load balancing, etc.

### EXAMPLE PROCEDURES

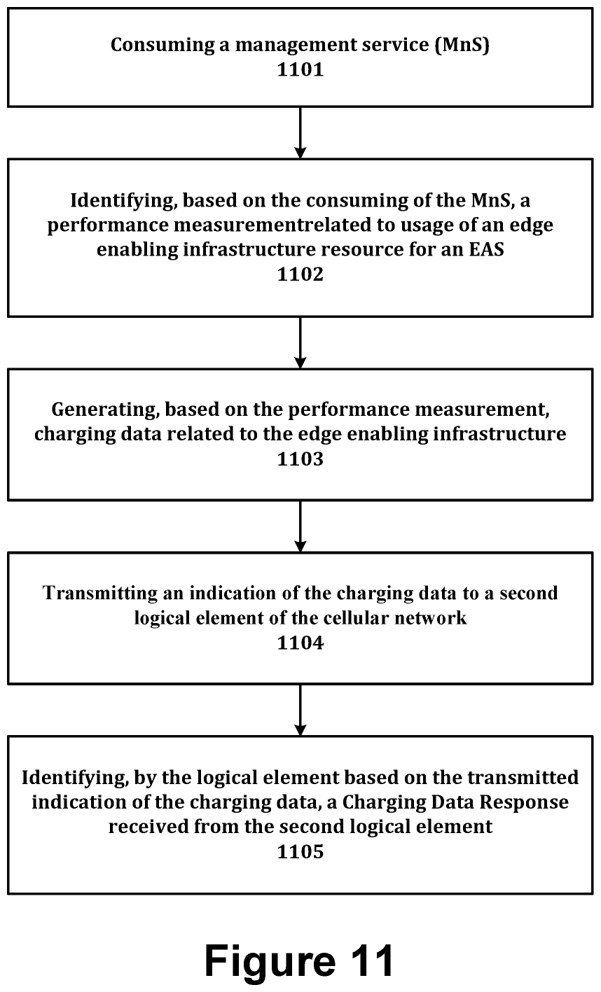

In some embodiments, the electronic device(s), network(s), system(s), chip(s) or component(s), or portions or implementations thereof, of FIGS. 7-10, or some other figure herein, may be configured to perform one or more processes, techniques, or methods as described herein, or portions thereof. One such process is depicted in FIG. 11. The process may be performed, for example, by a logical element of a cellular system (including the network, management system, charging and billing system) that is implemented by one or more processors of an electronic device. Such a logical element may be, for example, a charging enablement function (CEF). For example, the process may include, at 1101, consuming, by the logical element, a management service (MnS). The process may further include, at 1102, identifying, by the logical element based on the consuming of the MnS, a performance measurement related to usage of an edge enabling infrastructure resource for an edge application server (EAS). The process may further include, at 1103, generating, by the logical element based on the performance measurement, charging data related to the edge enabling infrastructure. The process may further include, at 1104, transmitting, by the logical element, an indication of the charging data to a second logical element of the cellular system. The process may further include, at 1105, identifying, by the logical element based on the transmitted indication of the charging data, a charging data response received from the second logical element.

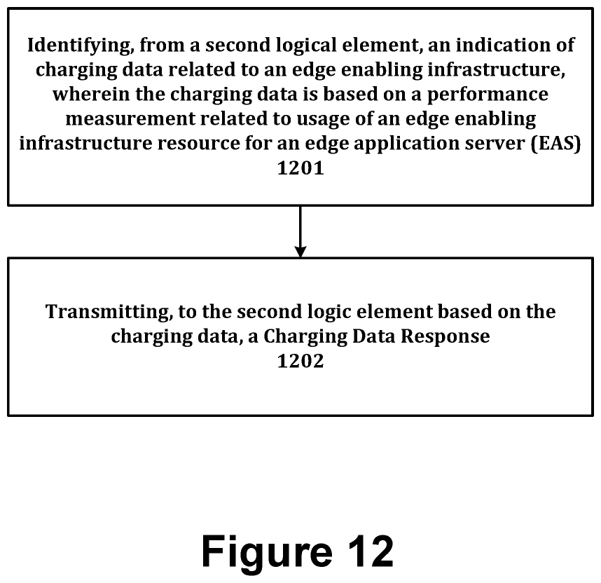

Another such process is depicted in FIG. 12. The process of FIG. 12 may be performed, for example, by a logical element of a cellular system that is implemented by one or more processors of an electronic device. Such a logical element may be, for example, a charging function (CHF). The process may include identifying, at 1201 from a second logical element, an indication of charging data related to an edge enabling infrastructure, wherein the charging data is based on a performance measurement related to usage of an edge enabling infrastructure resource for an edge application server (EAS); and transmitting, at 1202 to the second logical element based on the charging data, a Charging Data Response.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

Example 1 may include a CEF supported by one or more processors, is configured to:

Consume the MnS(s) to get the performance measurements related to the usage of edge enabling infrastructure resource for an EAS;

Generate charging data for the collected performance measurements related to the usage of edge enabling infrastructure resource;

Send a Charging Data Request containing the generated charging data to a CHF; and

Receive a Charging Data Response from the CHF.

Example 2 may include the method of example 1 or some other example herein, wherein the CEF consumes the MnS(s) to get the performance measurements related to the usage of edge enabling infrastructure resource for an EAS, comprising at least one of the following:
Creating one or more measurement job(s);
Subscribing to the file ready notifications;
Receiving the file ready notifications;
Fetching the performance data file according to the information provided in the file ready notifications;
Receiving the request to establish the streaming connection;
Establishing the streaming connection;
Receiving the stream data report on the streaming connection.

Example 3 may include the method of examples 1 and 2 or some other example herein, wherein the performance measurements related to the usage of edge enabling infrastructure resource for an EAS include at least one of the following:

virtual CPU usage (see VR. VCpuUsageMean in clause 5.7.1.1.1 of TS 28.552 [x]);

virtual memory usage (see VR. VMemory UsageMean in clause 5.7.1.2.1 of TS 28.552 [x]);

virtual disk usage (see VR. VDiskUsageMean in clause 5.7.1.3.1 in TS 28.552 [x]);

incoming data volume (see DataVolum.InBytesEAS in clause 5.7.2.1 of TS 28.552 [x]);

outgoing data volume (see DataVolum. OutBytesEAS in clause 5.7.2.2 of TS 28.552 [x]).

Example 4 may include the method of example 1 or some other example herein, wherein the Charging Data Request contains at least one of the following information:

One-time Event;

One-time Event Type;

NF Consumer Identification;

Invocation Timestamp;

Invocation Sequence Number;

EAS ID

EDN ID

EAS Provider Identifier

Edge Enabling Infrastructure Resource Usage Charging Information

Example 5 may include the method of example 1 or some other example herein, wherein the CHF supports charging of edge enabling infrastructure resource usage, comprising:
Receiving a Charging Data Request for edge enabling infrastructure resource usage charging from a CEF;
Creating a CDR for the Charging Data Request;
Reporting the CDR to Billing Domain;
Sending a Charging Data Response to the CEF.

Example 6 may include the method of example 5 or some other example herein, wherein the CDR contains at least one of the following information:

Record Type;

Recording Network Function ID;

NF Consumer Identification;

Record Opening Time;

Record Sequence Number;

Cause for Record Closing;

Diagnostics;

Local Record Sequence Number;

Record Extensions;

EAS ID

EDN ID

EAS Provider Identifier

Edge Enabling Infrastructure Resource Usage Charging Information

Example 7 may include the method of examples 4 and 6 or some other example herein, wherein the Edge Enabling Infrastructure Resource Usage Charging Information contains at least one of the following information:

virtual CPU usage (see VR. VCpuUsageMean in clause 5.7.1.1.1 of TS 28.552 [x]);

virtual memory usage (see VR. VMemory UsageMean in clause 5.7.1.2.1 of TS 28.552 [x]);

virtual disk usage (see VR. VDiskUsageMean in clause 5.7.1.3.1 in TS 28.552 [x]);

incoming data volume (see DataVolum. InBytesEAS in clause 5.7.2.1 of TS 28.552 [x]);

outgoing data volume (see DataVolum. OutBytesEAS in clause 5.7.2.2 of TS 28.552 [x]).

Duration start time;

Duration end time.

Example 8 may include the method of examples 1 and 5 or some other example herein, wherein the Charging Data Response contains at least one of the following information:

Invocation Timestamp;

Invocation Result;

Invocation Sequence Number;

Triggers.

Example 9 may include the method of example 8 or some other example herein, wherein each trigger contains at least one of the following information:

Resource usage type;

Active or not;

Duration period;

Threshold for usage reporting.

Example 10 may include the method of examples 1 and 9 wherein the default triggers are (pre)configured at the CEF.

Example 11 may include the method of example 8, 9 and 10 or some other example herein, wherein the default triggers are overridden by the triggers contained in the Charging Data Response.

Example 12 may include a method to be performed by a logical element of a cellular system implemented by one or more processors of an electronic device, wherein the method comprising:

consuming, by the logical element, a management service (MnS);

identifying, by the logical element based on the consuming of the MnS, performance measurements related to usage of an edge enabling infrastructure resource for an edge application server (EAS);

generating, by the logical element based on the performance measurements, charging data related to the edge enabling infrastructure;

transmitting, by the logical element, an indication of the charging data to a second logical element of the cellular system; and identifying, by the logical element based on the transmitted indication of the charging data, a charging data response received from the second logical element.

Example 13 may include the method of example 12, or some other example herein, wherein the logical element is a charging enablement function (CEF).

Example 14 may include the method of example 12, or some other example herein, wherein the second logical element is a charging function (CHF).

Example 15 may include the method of example 12, or some other example herein, wherein the cellular system is a fifth generation (5G) cellular system.

Example 16 may include a method to be performed by a logical element of a cellular system, wherein the method comprises consuming a management service (MnS); identifying, based on consumption of the MnS, a performance measurement related to usage of an edge enabling infrastructure resource for an edge application server (EAS); generating, based on the performance measurement, charging data related to the edge enabling infrastructure; transmitting an indication of the charging data to a second logical element of the cellular network; and identifying, based on the transmitted indication of the charging data, a Charging Data Response received from the second logical element.

Example 17 may include the method of example 16, and/or some other example herein, wherein the logical element is a charging enablement function (CEF).

Example 18 may include the method of any of examples 16-17, and/or some other example herein, wherein the second logical element is a charging function (CHF).

Example 19 may include the method of any of examples 16-18, and/or some other example herein, wherein the performance measurement is related to virtual central processing unit (CPU) usage, virtual memory usage, virtual disk usage, incoming data volume, or outgoing data volume.

Example 20 may include the method of any of examples 16-19, and/or some other example herein, further comprising transmitting the indication of the charging data to the second logical element of the cellular system in a Charging Data Request.

Example 21 may include a method to be implemented by a logical element of a cellular system, wherein the method comprises identifying, from a second logical element, an indication of charging data related to an edge enabling infrastructure, wherein the charging data is based on a performance measurement related to usage of an edge enabling infrastructure resource for an edge application server (EAS); and transmitting, to the second logical element based on the charging data, a Charging Data Response.

Example 22 include the method of example 21, and/or some other example herein, wherein the second logical element is a charging enablement function (CEF).

Example 23 includes the method of any of examples 21-22, and/or some other example herein, wherein the logical element is a charging function (CHF).

Example 24 includes the method of any of examples 21-23, and/or some other example herein, wherein the performance measurement is related to virtual central processing unit (CPU) usage, virtual memory usage, virtual disk usage, incoming data volume, or outgoing data volume.

Example 25 includes the method of any of examples 21-24, and/or some other example herein, wherein the indication of the charging data is received in a Charging Data Request.

Example Z01 may include an apparatus comprising means to perform one or more elements of a method described in or related to any of examples 1-25, or any other method or process described herein.

Example Z02 may include one or more non-transitory computer-readable media comprising instructions to cause an electronic device, upon execution of the instructions by one or more processors of the electronic device, to perform one or more elements of a method described in or related to any of examples 1-25, or any other method or process described herein.

Example Z03 may include an apparatus comprising logic, modules, or circuitry to perform one or more elements of a method described in or related to any of examples 1-25, or any other method or process described herein.

Example Z04 may include a method, technique, or process as described in or related to any of examples 1-25, or portions or parts thereof.

Example Z05 may include an apparatus comprising: one or more processors and one or more computer-readable media comprising instructions that, when executed by the one or more processors, cause the one or more processors to perform the method, techniques, or process as described in or related to any of examples 1-25, or portions thereof.

Example Z06 may include a signal as described in or related to any of examples 1-25, or portions or parts thereof.

Example Z07 may include a datagram, packet, frame, segment, protocol data unit (PDU), or message as described in or related to any of examples 1-25, or portions or parts thereof, or otherwise described in the present disclosure.

Example Z08 may include a signal encoded with data as described in or related to any of examples 1-25, or portions or parts thereof, or otherwise described in the present disclosure.

Example Z09 may include a signal encoded with a datagram, packet, frame, segment, protocol data unit (PDU), or message as described in or related to any of examples 1-25, or portions or parts thereof, or otherwise described in the present disclosure.

Example Z10 may include an electromagnetic signal carrying computer-readable instructions, wherein execution of the computer-readable instructions by one or more processors is to cause the one or more processors to perform the method, techniques, or process as described in or related to any of examples 1-25, or portions thereof.

Example Z11 may include a computer program comprising instructions, wherein execution of the program by a processing element is to cause the processing element to carry out the method, techniques, or process as described in or related to any of examples 1-25, or portions thereof.

Example Z12 may include a signal in a wireless network as shown and described herein.

Example Z13 may include a method of communicating in a wireless network as shown and described herein.

Example Z14 may include a system for providing wireless communication as shown and described herein.

Example Z15 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### Abbreviations

Unless used differently herein, terms, definitions, and abbreviations may be consistent with terms, definitions, and abbreviations defined in 3GPP TR 21.905 v16.0.0 (2019-06). For the purposes of the present document, the following abbreviations may apply to the examples and embodiments discussed herein.

| | |
|---|---|
| 3GPP | Third Generation |
| | Partnership Project |
| 4G | Fourth Generation |
| 5G | Fifth Generation |
| 5GC | 5G Core network |
| AC | Application Client |
| ACR | Application |
| | Context Relocation |
| ACK | Acknowledgement |
| ACID | Application |
| | Client Identification |
| AF | Application Function |
| AM | Acknowledged Mode |
| AMBR | Aggregate Maximum |
| | Bit Rate |
| AMF | Access and Mobility |
| | Management |
| | Function |
| AN | Access Network |
| ANR | Automatic |
| | Neighbour Relation |
| AOA | Angle of Arrival |
| AP | Application Protocol, |
| | Antenna Port, |
| | Access Point |
| API | Application |
| | Programming Interface |
| APN | Access Point Name |
| ARP | Allocation and |
| | Retention Priority |
| ARQ | Automatic Repeat |
| | Request |
| AS | Access Stratum |
| ASP | Application Service |
| | Provider |
| ASN.1 | Abstract Syntax |
| | Notation One |
| AUSF | Authentication |
| | Server Function |
| AWGN | Additive White |
| | Gaussian Noise |
| BAP | Backhaul |
| | Adaptation Protocol |
| BCH | Broadcast Channel |
| BER | Bit Error Ratio |
| BFD | Beam Failure Detection |
| BLER | Block Error Rate |
| BPSK | Binary Phase |
| | Shift Keying |
| BRAS | Broadband Remote |
| | Access Server |
| BSS | Business |
| | Support System |
| BS | Base Station |
| BSR | Buffer Status Report |
| BW | Bandwidth |
| BWP | Bandwidth Part |
| C-RNTI | Cell Radio Network |
| | Temporary Identity |
| CA | Carrier Aggregation, |
| | Certification Authority |
| CAPEX | CAPital EXpenditure |
| CBRA | Contention Based |
| | Random Access |
| CC | Component Carrier, |
| | Country Code, |
| | Cryptographic |
| | Checksum |
| CCA | Clear Channel |
| | Assessment |
| CCE | Control Channel |
| | Element |
| CCCH | Common Control |
| | Channel |
| CE | Coverage Enhancement |
| CDM | Content Delivery |
| | Network |
| CDMA | Code-Division Multiple |
| | Access |
| CDR | Charging Data Request |
| CDR | Charging Data |
| | Response |
| CFRA | Contention Free |
| | Random Access |
| CG | Cell Group |
| CGF | Charging Gateway |
| | Function |
| CHF | Charging Function |
| CI | Cell Identity |
| CID | Cell-ID (e.g., |
| | positioning method) |
| CIM | Common Information |
| | Model |
| CIR | Carrier to Interference |
| | Ratio |
| CK | Cipher Key |
| CM | Connection |
| | Management, |
| | Conditional Mandatory |
| CMAS | Commercial Mobile |
| | Alert Service |
| CMD | Command |
| CMS | Cloud Management |
| | System |
| CO | Conditional Optional |
| CoMP | Coordinated |
| | Multi-Point |
| CORSET | Control Resource Set |
| COTS | Commercial Off-The- |
| | Shelf |
| CP | Control Plane, Cyclic |
| | Prefix Connection Point |
| CPD | Connection Point |
| | Descriptor |
| CPE | Customer Premise |
| | Equipment |
| CPICH | Common Pilot Channel |
| CQI | Channel Quality |
| | Indicator |
| CPU | CSI processing unit, |
| | Central Processing Unit |
| C/R | Command/Response |
| | field bit |
| CRAN | Cloud Radio Access |
| | Network, Cloud RAN |
| CRB | Common Resource |
| | Block |
| CRC | Cyclic Redundancy |
| | Check |
| CRI | Channel-State |
| | Information Resource |
| | Indicator, CSI-RS |
| | Resource Indicator |
| C-RNTI | Cell RNTI |
| CS | Circuit Switched |
| CSCF | call session control |
| | function |
| CSAR | Cloud Service Archive |
| CSI | Channel-State |
| | Information |
| CSI-IM | CSI Interference |
| | Measurement |
| CSI-RS | CSI Reference Signal |
| CSI-RSRP | CSI reference signal |
| | received power |
| CSI-RSRQ | CSI reference signal |
| | received quality |
| CSI-SINR | CSI signal-to-noise and |
| | interference ratio |
| CSMA | Carrier Sense Multiple |
| | Access |
| CSMA/CA | CSMA with collision |
| | avoidance |
| CSS | Common Search Space, |
| | Cell-specific Search Space |
| CTF | Charging Trigger |
| | Function |
| CTS | Clear-to-Send |
| CW | Codeword |
| CWS | Contention Window Size |
| D2D | Device-to- |
| | Device |
| DC | Dual Connectivity, |
| | Direct Current |
| DCI | Downlink Control |
| | Information |
| DF | Deployment Flavour |
| DL | Downlink |
| DMTF | Distributed |
| | Management Task |
| | Force |
| DPDK | Data Plane |
| | Development Kit |
| DM-RS, DMRS | Demodulation |
| | Reference Signal |
| DN | Data network |
| DNN | Data Network Name |
| DNAI | Data Network |
| | Access Identifier |
| DRB | Data Radio Bearer |
| DRS | Discovery |
| | Reference Signal |
| DRX | Discontinuous |
| | Reception |
| DSL | Domain Specific |
| | Language. Digital |
| | Subscriber Line |
| DSLAM | DSL |
| | Access Multiplexer |
| DwPTS | Downlink Pilot |
| | Time Slot |
| E-LAN | Ethernet Local |
| | Area Network |
| E2E | End-to-End |
| EAS | Edge |
| | Application Server |
| ECCA | extended clear |
| | channel assessment, |
| | extended CCA |
| ECCE | Enhanced Control |
| | Channel Element, |
| | Enhanced CCE |
| ED | Energy Detection |
| EDGE | Enhanced |
| | Datarates for GSM |
| | Evolution (GSM |
| | Evolution) |
| EAS | Edge |
| | Application Server |
| EASID | Edge Application |
| | Server Identification |
| ECS | Edge |
| | Configuration Server |
| ECSP | Edge Computing |
| | Service Provider |
| EDN | Edge Data Network |
| EEC | Edge Enabler Client |
| EECID | Edge Enabler |
| | Client Identification |
| EES | Edge |
| | Enabler Server |
| EESID | Edge Enabler Server |
| | Identification |
| EHE | Edge Hosting |
| | Environment |
| EGMF | Exposure Governance |
| | Management |
| | Function |
| EGPRS | Enhanced GPRS |
| EIR | Equipment Identity |
| | Register |
| eLAA | enhanced Licensed |
| | Assisted Access, |
| | enhanced LAA |
| EM | Element Manager |
| eMBB | Enhanced Mobile |
| | Broadband |
| EMS | Element |
| | Management System |
| eNB | evolved NodeB, |
| | E-UTRAN Node B |
| EN-DC | E-UTRA-NR Dual |
| | Connectivity |
| EPC | Evolved Packet Core |
| EPDCCH | enhanced PDCCH, |
| | enhanced Physical |
| | Downlink Control |
| | Cannel |
| EPRE | Energy per |
| | resource element |
| EPS | Evolved Packet |
| | System |
| EREG | enhanced REG, |
| | enhanced resource |
| | element groups |
| ETSI | European |
| | Telecommunications |
| | Standards Institute |
| ETWS | Earthquake and |
| | Tsunami Warning |
| | System |
| eUICC | embedded UICC, |
| | embedded Universal |
| | Integrated Circuit |
| | Card |
| E-UTRA | Evolved UTRA |
| E-UTRAN | Evolved UTRAN |
| EV2X | Enhanced V2X |
| F1AP | F1 Application Protocol |
| F1-C | F1 Control plane interface |
| F1-U | F1 User plane interface |
| FACCH | Fast Associated |
| | Control CHannel |
| FACCH/F | Fast Associated |
| | Control Channel/ |
| | Full rate |
| FACCH/H | Fast Associated |
| | Control Channel/ |
| | Half rate |
| FACH | Forward Access |
| | Channel |
| FAUSCH | Fast Uplink |
| | Signalling Channel |
| FB | Functional Block |
| FBI | Feedback Information |
| FCC | Federal |
| | Communications |
| | Commission |
| FCCH | Frequency |
| | Correction CHannel |
| FDD | Frequency |
| | Division Duplex |
| FDM | Frequency |
| | Division Multiplex |
| FDMA | Frequency Division |
| | Multiple Access |
| FE | Front End |
| FEC | Forward Error |
| | Correction |
| FFS | For Further Study |
| FFT | Fast Fourier |
| | Transformation |
| feLAA | further enhanced |
| | Licensed Assisted |
| | Access, further |
| | enhanced LAA |
| FN | Frame Number |
| FPGA | Field-Programmable |
| | Gate Array |
| FR | Frequency Range |
| FQDN | Fully Qualified |
| | Domain Name |
| G-RNTI | GERAN Radio |
| | Network Temporary |
| | Identity |
| GERAN | GSM EDGE RAN, |
| | GSM EDGE Radio |
| | Access Network |
| GGSN | Gateway GPRS |
| | Support Node |
| GLONASS | GLObal'naya |
| | NAvigatsionnay |
| | a Sputnikovaya |
| | Sistema (Engl .: |
| | Global Navigation |
| | Satellite System) |
| gNB | Next Generation |
| | NodeB |
| gNB-CU | gNB-centralized unit, |
| | Next Generation |
| | NodeB |
| | centralized unit |
| gNB-DU | gNB-distributed unit, |
| | Next Generation |
| | NodeB distributed unit |
| GNSS | Global Navigation |
| | Satellite System |
| GPRS | General Packet |
| | Radio Service |
| GPSI | Generic Public |
| | Subscription Identifier |
| GSM | Global System for |
| | Mobile |
| | Communications, |
| | Groupe Spécial |
| | Mobile |
| GTP | GPRS Tunneling |
| | Protocol |
| GTP-UGPRS | Tunnelling Protocol |
| | for User Plane |
| GTS | Go To Sleep |
| | Signal (related to |
| | WUS) |
| GUMMEI | Globally Unique |
| | MME Identifier |
| GUTI | Globally Unique |
| | Temporary UE |
| | Identity |
| HARQ | Hybrid ARQ, |
| | Hybrid Automatic |
| | Repeat Request |
| HANDO | Handover |
| HFN | HyperFrame Number |
| HHO | Hard Handover |
| HLR | Home Location |
| | Register |
| HN | Home Network |
| HO | Handover |
| HPLMN | Home Public |
| | Land Mobile Network |
| HSDPA | High Speed |
| | Downlink Packet Access |
| HSN | Hopping Sequence |
| | Number |
| HSPA | High Speed |
| | Packet Access |
| HSS | Home |
| | Subscriber Server |
| HSUPA | High Speed Uplink |
| | Packet Access |
| HTTP | Hyper Text Transfer |
| | Protocol |
| HTTPS | Hyper Text Transfer |
| | Protocol Secure |
| | http/1.1 over |
| | SSL, i.e. port 443) |
| I-Block | Information Block |
| ICCID | Integrated Circuit Card |
| | Identification |
| IAB | Integrated Access |
| | and Backhaul |
| ICIC | Inter-Cell Interference |
| | Coordination |
| ID | Identity, identifier |
| IDFT | Inverse Discrete |
| | Fourier Transform |
| IE | Information element |
| IBE | In-Band Emission |
| IEEE | Institute of Electrical |
| | and Electronics |
| | Engineers |
| IEI | Information |
| | Element Identifier |
| IEIDL | Information Element |
| | Identifier Data Length |
| IETF | Internet Engineering |
| | Task Force |
| IF | Infrastructure |
| IIOT | Industrial Internet |
| | of Things |
| IM | Interference |
| | Measurement, |
| | Intermodulation, |
| IP | Multimedia |
| IMC | IMS Credentials |
| IMEI | International |
| | Mobile Equipment |
| | Identity |
| IMGI | International mobile |
| | group identity |
| IMPI | IP Multimedia |
| | Private Identity |
| IMPU | IP Multimedia |
| | PUblic identity |
| IMS | IP Multimedia |
| | Subsystem |
| IMSI | International Mobile |
| | Subscriber Identity |
| IoT | Internet of Things |
| IP | Internet Protocol |
| Ipsec | IP Security, |
| | Internet Protocol |
| | Security |
| IP-CAN | IP-Connectivity |
| | Access Network |
| IP-M | IP Multicast |
| IPv4 | Internet Protocol |
| | Version 4 |
| IPv6 | Internet Protocol |
| | Version 6 |
| IR | Infrared |
| IS | In Sync |
| IRP | Integration |
| | Reference Point |
| ISDN | Integrated Services |
| | Digital Network |
| ISIM | IM Services |
| | Identity Module |
| ISO | International |
| | Organisation for |
| | Standardisation |
| ISP | Internet Service |
| | Provider |
| IWF | Interworking-Function |
| I-WLAN | Interworking WLAN |
| | Constraint length |
| | of the convolutional |
| | code, USIM |
| | Individual key |
| kB | Kilobyte (1000 bytes) |
| kbps | kilo-bits per second |
| Kc | Ciphering key |
| Ki | Individual subscriber |
| | authentication key |
| KPI | Key |
| | Performance Indicator |
| KQI | Key Quality |
| | Indicator |
| KSI | Key Set Identifier |
| ksps | kilo-symbols per |
| | second |
| KVM | Kernel Virtual |
| | Machine |
| L1 | Layer 1 (physical layer) |
| L1-RSRP | Layer 1 reference |
| | signal received power |
| L2 | Layer 2 (data link layer) |
| L3 | Layer 3 (network |
| | layer) |
| LAA | Licensed |
| | Assisted Access |
| LAN | Local Area Network |
| LADN | Local Area Data |
| | Network |
| LBT | Listen Before Talk |
| LCM | LifeCycle |
| | Management |
| LCR | Low Chip Rate |
| LCS | Location Services |
| LCID | Logical Channel ID |
| LI | Layer Indicator |
| LLC | Logical Link |
| | Control, Low Layer |
| | Compatibility |
| LMF | Location |
| | Management Function |
| LOS | Line of Sight |
| LPLMN | Local PLMN |
| LPP | LTE Positioning |
| | Protocol |
| LSB | Least Significant Bit |
| LTE | Long Term Evolution |
| LWA | LTE-WLAN |
| | aggregation |
| LWIP | LTE/WLAN |
| | Radio Level |
| | Integration with |
| | IPsec Tunnel |
| LTE | Long Term Evolution |
| M2M | Machine-to-Machine |
| MAC | Medium Access |
| | Control (protocol |
| | layering context) |
| MAC | Message |
| | authentication code |
| | (security/encryption |
| | context) |
| MAC-A | MAC used for |
| | authentication and |
| | key agreement (TSG |
| | T WG3 context) |
| MAC-IMAC | used for data integrity |
| | of signalling messages |
| | (TSG T WG3 context) |
| MANO | Management and |
| | Orchestration |
| MBMS | Multimedia Broadcast |
| | and Multicast Service |
| MBSFN | Multimedia Broadcast |
| | multicast service Single |
| | Frequency Network |
| MCC | Mobile Country Code |
| MCG | Master Cell Group |
| MCOT | Maximum Channel |
| | Occupancy Time |
| MCS | Modulation and |
| | coding scheme |
| MDAF | Management Data |
| | Analytics Function |
| MDAS | Management Data |
| | Analytics Service |
| MDT | Minimization of |
| | Drive Tests |
| ME | Mobile Equipment |
| MeNB | master eNB |
| MER | Message Error Ratio |
| MGL | Measurement Gap |
| | Length |
| MGRP | Measurement Gap |
| | Repetition Period |
| MIB | Master Information |
| | Block, Management |
| | Information Base |
| MIMO | Multiple Input |
| | Multiple Output |
| MLC | Mobile Location Centre |
| MM | Mobility Management |
| MME | Mobility |
| | Management Entity |
| MN | Master Node |
| MNO | Mobile Network |
| | Operator |
| MO | Measurement Object, |
| | Mobile Originated |
| MPBCH | MTC Physical |
| | Broadcast CHannel |
| MPDCCH | MTC |
| | Physical Downlink |
| | Control CHannel |
| MPDSCH | MTC Physical |
| | Downlink Shared |
| | CHannel |
| MPRACH | MTC |
| | Physical Random |
| | Access CHannel |
| MPUSCH | MTC Physical |
| | Uplink Shared Channel |
| MPLS | MultiProtocol |
| | Label Switching |
| MS | Mobile Station |
| MSB | Most Significant Bit |
| MSC | Mobile |
| | Switching Centre |
| MSI | Minimum System |
| | Information, MCH |
| | Scheduling |
| | Information |
| MSID | Mobile Station |
| | Identifier |
| MSIN | Mobile Station |
| | Identification Number |
| MSISDN | Mobile Subscriber |
| | ISDN Number |
| MT | Mobile Terminated, |
| | Mobile Termination |
| MTC | Machine-Type |
| | Communications |
| mMTC | massive MTC, |
| | massive Machine- |
| | Type Communications |
| MU-MIMO | Multi User MIMO |
| MWUS | MTC wake-up signal, |
| | MTC WUS |
| NACK | Negative |
| | Acknowledgement |
| NAI | Network Access |
| | Identifier |
| NAS | Non-Access |
| | Stratum, Non-Access |
| | Stratum layer |
| NCT | Network |
| | Connectivity Topology |
| NC-JT | Non-Coherent Joint |
| | Transmission |
| NEC | Network |
| | Capability Exposure |
| NE-DC | NR-E-UTRA |
| | Dual Connectivity |
| NEF | Network Exposure |
| | Function |
| NF | Network Function |
| NFP | Network |
| | Forwarding Path |
| NFPD | Network Forwarding |
| | Path Descriptor |
| NFV | Network Functions |
| | Virtualization |
| NFVI | NFV Infrastructure |
| NFVO | NFV Orchestrator |
| NG | Next Generation, |
| | Next Gen |
| NGEN-DC | NG-RAN |
| | E-UTRA-NR Dual |
| | Connectivity |
| NM | Network Manager |
| NMS | Network |
| | Management System |
| N-PoP | Network Point of |
| | Presence |
| NMIB, N-MIB | Narrowband MIB |
| NPBCH | Narrowband Physical |
| | Broadcast CHannel |
| NPDCCH | Narrowband Physical |
| | Downlink |
| | Control CHannel |
| NPDSCH | Narrowband Physical |
| | Downlink |
| | Shared CHannel |
| NPRACH | Narrowband |
| | Physical Random |
| | Access CHannel |
| NPUSCH | Narrowband |
| | Physical Uplink |
| | Shared CHannel |
| NPSS | Narrowband Primary |
| | Synchronization Signal |
| NSSS | Narrowband Secondary |
| | Synchronization Signal |
| NR | New Radio, |
| | Neighbour Relation |
| NRF | NF Repository |
| | Function |
| NRS | Narrowband |
| | Reference Signal |
| NS | Network Service |
| NSA | Non-Standalone |
| | operation mode |
| NSD | Network Service |
| | Descriptor |
| NSR | Network Service |
| | Record |
| NSSAI | Network Slice |
| | Selection Assistance |
| | Information |
| S-NNSAI | Single-NSSAI |
| NSSF | Network Slice |
| | Selection Function |
| NW | Network |
| NWUS | Narrowband |
| | wake-up signal, |
| | Narrowband WUS |
| NZP | Non-Zero Power |
| O&M | Operation and |
| | Maintenance |
| ODU2 | Optical channel |
| | Data Unit-type 2 |
| OFDM | Orthogonal Frequency |
| | Division Multiplexing |
| OFDMA | Orthogonal Frequency |
| | Division Multiple |
| | Access |
| OOB | Out-of-band |
| OOS | Out of Sync |
| OPEX | OPerating EXpense |
| OSI | Other System |
| | Information |
| OSS | Operations |
| | Support System |
| OTA | over-the-air |
| PAPR | Peak-to-Average |
| | Power Ratio |
| PAR | Peak to Average Ratio |
| PBCH | Physical Broadcast |
| | Channel |
| PC | Power Control, |
| | Personal Computer |
| PCC | Primary Component |
| | Carrier, Primary CC |
| P-CSCF | Proxy CSCF |
| PCell | Primary Cell |
| PCI | Physical Cell ID, |
| | Physical Cell Identity |
| PCEF | Policy and Charging |
| | Enforcement |
| | Function |
| PCF | Policy Control |
| | Function |
| PCRF | Policy Control |
| | and Charging Rules |
| | Function |
| PDCP | Packet Data |
| | Convergence Protocol, |
| | Packet Data |
| | Convergence |
| | Protocol layer |
| PDCCH | Physical Downlink |
| | Control Channel |
| PDCP | Packet Data |
| | Convergence Protocol |
| PDN | Packet Data |
| | Network, Public |
| | Data Network |
| PDSCH | Physical Downlink |
| | Shared Channel |
| PDU | Protocol Data Unit |
| PEI | Permanent Equipment |
| | Identifiers |
| PFD | Packet Flow Description |
| P-GW | PDN Gateway |
| PHICH | Physical hybrid- |
| | ARQ indicator |
| | channel |
| PHY | Physical layer |
| PLMN | Public Land |
| | Mobile Network |
| PIN | Personal |
| | Identification Number |
| PM | Performance |
| | Measurement |
| PMI | Precoding |
| | Matrix Indicator |
| PNF | Physical |
| | Network Function |
| PNFD | Physical Network |
| | Function Descriptor |
| PNFR | Physical Network |
| | Function Record |
| POC | PTT over Cellular |
| PP, PTP | Point-to-Point |
| PPP | Point-to-Point |
| | Protocol |
| PRACH | Physical RACH |
| PRB | Physical resource block |
| PRG | Physical resource block |
| | group |
| ProSe | Proximity Services, |
| | Proximity-Based |
| | Service |
| PRS | Positioning Reference |
| | Signal |
| PRR | Packet Reception |
| | Radio |
| PS | Packet Services |
| PSBCH | Physical Sidelink |
| | Broadcast Channel |
| PSDCH | Physical Sidelink |
| | Downlink Channel |
| PSCCH | Physical Sidelink |
| | Control Channel |
| PSSCH | Physical Sidelink |
| | Shared Channel |
| PSCell | Primary SCell |
| PSS | Primary |
| | Synchronization |
| | Signal |
| PSTN | Public Switched |
| | Telephone Network |
| PT-RS | Phase-tracking |
| | reference signal |
| PTT | Push-to-Talk |
| PUCCH | Physical Uplink |
| | Control Channel |
| PUSCH | Physical Uplink |
| | Shared Channel |
| QAM | Quadrature Amplitude |
| | Modulation |
| QCI | QoS class of identifier |
| QCL | Quasi co-location |
| QFI | QoS Flow ID, |
| | QoS Flow Identifier |
| QoS | Quality of Service |
| QPSK | Quadrature (Quaternary) |
| | Phase Shift Keying |
| QZSS | Quasi-Zenith Satellite |
| | System |
| RA-RNTI | Random Access RNTI |
| RAB | Radio Access Bearer, |
| | Random Access Burst |
| RACH | Random Access |
| | Channel |
| RADIUS | Remote Authentication |
| | Dial In User Service |
| RAN | Radio Access |
| | Network |
| RAND | RANDom number |
| | (used for |
| | authentication) |
| RAR | Random Access |
| | Response |
| RAT | Radio Access |
| | Technology |
| RAU | Routing Area Update |
| RB | Resource block, Radio |
| | Bearer |
| RBG | Resource block group |
| REG | Resource Element |
| | Group |
| Rel | Release |
| REQ | REQuest |
| RF | Radio Frequency |
| RI | Rank Indicator |
| RIV | Resource indicator |
| | value |
| RL | Radio Link |
| RLC | Radio Link Control, |
| | Radio Link Control |
| | layer |
| RLC AM | RLC Acknowledged |
| | Mode |
| RLC UM | RLC |
| | Unacknowledged Mode |
| RLF | Radio Link Failure |
| RLM | Radio Link |
| | Monitoring |
| RLM-RS | Reference Signal |
| | for RLM |
| RM | Registration |
| | Management |
| RMC | Reference |
| | Measurement Channel |
| RMSI | Remaining MSI, |
| | Remaining |
| | Minimum System |
| | Information |
| RN | Relay Node |
| RNC | Radio Network |
| | Controller |
| RNL | Radio Network |
| | Layer |
| RNTI | Radio Network |
| | Temporary Identifier |
| ROHC | RObust Header |
| | Compression |
| RRC | Radio Resource |
| | Control, Radio |
| | Resource Control |
| | layer |
| RRM | Radio Resource |
| | Management |
| RS | Reference Signal |
| RSRP | Reference Signal |
| | Received Power |
| RSRQ | Reference Signal |
| | Received Quality |
| RSSI | Received Signal |
| | Strength Indicator |
| RSU | Road Side Unit |
| RSTD | Reference Signal |
| | Time difference |
| RTP | Real Time Protocol |
| RTS | Ready-To-Send |
| RTT | Round Trip Time |
| Rx | Reception, |
| | Receiving, Receiver |
| S1AP | S1 Application |
| | Protocol |
| S1-MME | S1 for the control plane |
| S1-U | S1 for the user plane |
| S-CSCF | serving CSCF |
| S-GW | Serving Gateway |
| S-RNTI | SRNC |
| | Radio Network |
| | Temporary Identity |
| S-TMSI | SAE Temporary |
| | Mobile Station |
| | Identifier |
| SA | Standalone |
| | operation mode |
| SAE | System Architecture |
| | Evolution |
| SAP | Service Access |
| | Point |
| SAPD | Service Access |
| | Point Descriptor |
| SAPI | Service Access |
| | Point Identifier |
| SCC | Secondary |
| | Component Carrier, |
| | Secondary CC |
| SCell | Secondary Cell |
| SCEF | Service Capability |
| | Exposure Function |
| SC-FDMA | Single Carrier |
| | Frequency Division |
| | Multiple Access |
| SCG | Secondary Cell Group |
| SCM | Security Context |
| | Management |
| SCS | Subcarrier Spacing |
| SCTP | Stream Control |
| | Transmission Protocol |
| SDAP | Service Data |
| | Adaptation Protocol, |
| | Service Data |
| | Adaptation |
| | Protocol layer |
| SDL | Supplementary |
| | Downlink |
| SDNF | Structured Data |
| | Storage Network |
| | Function |
| SDP | Session |
| | Description Protocol |
| SDSF | Structured Data |
| | Storage Function |
| SDT | Small Data |
| | Transmission |
| SDU | Service Data Unit |
| SEAF | Security Anchor |
| | Function |
| SeNB | secondary eNB |
| SEPP | Security Edge |
| | Protection Proxy |
| SFI | Slot format |
| | indication |
| SFTD | Space-Frequency |
| | Time Diversity, SFN |
| | and frame timing |
| | difference |
| SFN | System Frame |
| | Number |
| SgNB | Secondary gNB |
| SGSN | Serving GPRS |
| | Support Node |
| S-GW | Serving Gateway |
| SI | System Information |
| SI-RNTI | System Information |
| | RNTI |
| SIB | System Information |
| | Block |
| SIM | Subscriber Identity |
| | Module |
| SIP | Session Initiated |
| | Protocol |
| SiP | System in Package |
| SL | Sidelink |
| SLA | Service Level |
| | Agreement |
| SM | Session Management |
| SMF | Session |
| | Management Function |
| SMS | Short Message |
| | Service |
| SMSF | SMS Function |
| SMTC | SSB-based |
| | Measurement Timing |
| | Configuration |
| SN | Secondary Node, |
| | Sequence Number |
| SoC | System on Chip |
| SON | Self-Organizing |
| | Network |
| SpCell | Special Cell |
| SP-CSI-RNTI | Semi-Persistent |
| | CSI RNTI |
| SPS | Semi-Persistent |
| | Scheduling |
| SQN | Sequence number |
| SR | Scheduling Request |
| SRB | Signalling Radio |
| | Bearer |
| SRS | Sounding Reference |
| | Signal |
| SS | Synchronization |
| | Signal |
| SSB | Synchronization |
| | Signal Block |
| SSID | Service Set |
| | Identifier |
| SS/PBCH | Block |
| SSBRI | SS/PBCH Block |
| | Resource Indicator, |
| | Synchronization |
| | Signal Block |
| | Resource Indicator |
| SSC | Session and |
| | Service Continuity |
| SS-RSRP | Synchronization |
| | Signal based |
| | Reference Signal |
| | Received Power |
| SS-RSRQ | Synchronization |
| | Signal based |
| | Reference Signal |
| | Received Quality |
| SS-SINR | Synchronization |
| | Signal based Signal to |
| | Noise and Interference |
| | Ratio |
| SSS | Secondary |
| | Synchronization |
| | Signal |
| SSSG | Search Space Set |
| | Group |
| SSSIF | Search Space Set |
| | Indicator |
| SST | Slice/Service Types |
| SU-MIMO | Single User MIMO |
| SUL | Supplementary Uplink |
| TA | Timing Advance, |
| | Tracking Area |
| TAC | Tracking Area Code |
| TAG | Timing Advance Group |
| TAI | Tracking Area Identity |
| TAU | Tracking Area Update |
| TB | Transport Block |
| TBS | Transport Block Size |
| TBD | To Be Defined |
| TCI | Transmission |
| | Configuration Indicator |
| TCP | Transmission |
| | Communication |
| | Protocol |
| TDD | Time Division Duplex |
| TDM | Time Division |
| | Multiplexing |
| TDMA | Time Division |
| | Multiple Access |
| TE | Terminal Equipment |
| TEID | Tunnel End Point |
| | Identifier |
| TFT | Traffic Flow Template |
| TMSI | Temporary Mobile |
| | Subscriber Identity |
| TNL | Transport Network Layer |
| TPC | Transmit Power Control |
| TPMI | Transmitted Precoding |
| | Matrix Indicator |
| TR | Technical Report |
| TRP, TRxP | Transmission |
| | Reception Point |
| TRS | Tracking Reference |
| | Signal |
| TRx | Transceiver |
| TS | Technical Specifications, |
| | Technical Standard |
| TTI | Transmission Time |
| | Interval |
| Tx | Transmission, |
| | Transmitting, |
| | Transmitter |
| U-RNTI | UTRAN Radio |
| | Network Temporary |
| | Identity |
| UART | Universal Asynchronous |
| | Receiver and |
| | Transmitter |
| UCI | Uplink Control |
| | Information |
| UE | User Equipment |
| UDM | Unified Data |
| | Management |
| UDP | User Datagram Protocol |
| UDSF | Unstructured Data |
| | Storage Network |
| | Function |
| UICC | Universal Integrated |
| | Circuit Card |
| UL | Uplink |
| UM | Unacknowledged Mode |
| UML | Unified Modelling |
| | Language |
| UMTS | Universal Mobile |
| | Telecommunications |
| | System |
| UP | User Plane |
| UPF | User Plane Function |
| URI | Uniform Resource |
| | Identifier |
| URL | Uniform Resource |
| | Locator |
| URLLC | Ultra-Reliable |
| | and Low Latency |
| USB | Universal Serial Bus |
| USIM | Universal Subscriber |
| | Identity Module |
| USS | UE-specific |
| | search space |
| UTRA | UMTS Terrestrial Radio |
| | Access |
| UTRAN | Universal Terrestrial |
| | Radio Access Network |
| UwPTS | Uplink Pilot Time Slot |
| V2I | Vehicle-to-Infrastruction |
| V2P | Vehicle-to-Pedestrian |
| V2V | Vehicle-to-Vehicle |
| V2X | Vehicle-to-everything |
| VIM | Virtualized |
| | Infrastructure Manager |
| VL | Virtual Link, |
| VLAN | Virtual LAN, Virtual |
| | Local Area Network |
| VM | Virtual Machine |
| VNF | Virtualized Network |
| | Function |
| VNFFG | VNF Forwarding Graph |
| VNFFGD | VNF Forwarding |
| | Graph Descriptor |
| VNFM | VNF Manager |
| VoIP | Voice-over-IP, |
| | Voice-over-Internet |
| | Protocol |
| VPLMN | Visited Public Land |
| | Mobile Network |
| VPN | Virtual Private Network |
| VRB | Virtual Resource Block |
| WiMAX | Worldwide |
| | Interoperability |
| | for Microwave Access |
| WLAN | Wireless Local Area |
| | Network |
| WMAN | Wireless Metropolitan |
| | Area Network |
| WPAN | Wireless Personal Area |
| | Network |
| X2-C | X2-Control plane |
| X2-U | X2-User plane |
| XML | eXtensible Markup |
| | Language |
| XRES | EXpected user |
| | RESponse |
| XOR | eXclusive OR |
| ZC | Zadoff-Chu |
| ZP | Zero Power |

### Terminology

For the purposes of the present document, the following terms and definitions are applicable to the examples and embodiments discussed herein.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

The term “SMTC” refers to an SSB-based measurement timing configuration configured by SSB-MeasurementTimingConfiguration.

The term “SSB” refers to an SS/PBCH block.

The term “a “Primary Cell” refers to the MCG cell, operating on the primary frequency, in which the UE either performs the initial connection establishment procedure or initiates the connection re-establishment procedure.

The term “Primary SCG Cell” refers to the SCG cell in which the UE performs random access when performing the Reconfiguration with Sync procedure for DC operation.

The term “Secondary Cell” refers to a cell providing additional radio resources on top of a Special Cell for a UE configured with CA.

The term “Secondary Cell Group” refers to the subset of serving cells comprising the PSCell and zero or more secondary cells for a UE configured with DC.

The term “Serving Cell” refers to the primary cell for a UE in RRC_CONNECTED not configured with CA/DC there is only one serving cell comprising of the primary cell.

The term “serving cell” or “serving cells” refers to the set of cells comprising the Special Cell(s) and all secondary cells for a UE in RRC_CONNECTED configured with CA/.

The term “Special Cell” refers to the PCell of the MCG or the PSCell of the SCG for DC operation; otherwise, the term “Special Cell” refers to the Pcell.

1.-20. (canceled)

21. One or more non-transitory computer-readable media comprising instructions that, upon implementation of the instructions by one or more processors of an electronic device in a cellular system, are to cause a logical element of the cellular system to:
consume a management service (MnS);
identify, based on consumption of the MnS, a performance measurement related to usage of an edge enabling infrastructure resource for an edge application server (EAS);
generate, based on the performance measurement, charging data related to the edge enabling infrastructure;
transmit an indication of the charging data to a second logical element of the cellular system; and
identify, based on the transmitted indication of the charging data, a Charging Data Response received from the second logical element.

22. The one or more non-transitory computer-readable media of claim 21, wherein the logical element is a charging enablement function (CEF).

23. The one or more non-transitory computer-readable media of claim 21, wherein the second logical element is a charging function (CHF).

24. The one or more non-transitory computer-readable media of claim 21, wherein the performance measurement is related to virtual central processing unit (CPU) usage, virtual memory usage, virtual disk usage, incoming data volume, or outgoing data volume.

25. The one or more non-transitory computer-readable media of claim 21, wherein the instructions are to transmit the indication of the charging data to the second logical element of the cellular system in a Charging Data Request.

26. An electronic device for use in a cellular system, wherein the electronic device comprises:
one or more processors to implement a logical element of a cellular system; and
one or more non-transitory computer-readable media comprising instructions that, upon implementation of the instructions by the one or more processors, are to cause the logical element of the cellular system to:
consume a management service (MnS);
identify, based on consumption of the MnS, a performance measurement related to usage of an edge enabling infrastructure resource for an edge application server (EAS);
generate, based on the performance measurement, charging data related to the edge enabling infrastructure;
transmit an indication of the charging data to a second logical element of the cellular system; and
identify, based on the transmitted indication of the charging data, a charging data response received from the second logical element.

27. The electronic device of claim 26, wherein the logical element is a charging enablement function (CEF).

28. The electronic device of claim 26, wherein the second logical element is a charging function (CHF).

29. The electronic device of claim 26, wherein the performance measurement is related to virtual central processing unit (CPU) usage, virtual memory usage, virtual disk usage, incoming data volume, or outgoing data volume.

30. The electronic device of claim 26, wherein the instructions are to transmit the indication of the charging data to the second logical element of the cellular system in a Charging Data Request.

31. One or more non-transitory computer-readable media comprising instructions that, upon implementation of the instructions by one or more processors of an electronic device in a cellular system, are to cause a logical element of the cellular system to:
identify, from a second logical element, an indication of charging data related to an edge enabling infrastructure, wherein the charging data is based on a performance measurement related to usage of an edge enabling infrastructure resource for an edge application server (EAS); and
transmit, to the second logical element based on the charging data, a Charging Data Response.

32. The one or more non-transitory computer-readable media of claim 31, wherein the second logical element is a charging enablement function (CEF).

33. The one or more non-transitory computer-readable media of claim 31, wherein the logical element is a charging function (CHF).

34. The one or more non-transitory computer-readable media of claim 31, wherein the performance measurement is related to virtual central processing unit (CPU) usage, virtual memory usage, virtual disk usage, incoming data volume, or outgoing data volume.

35. The one or more non-transitory computer-readable media of claim 31, wherein the indication of the charging data is received in a Charging Data Request.
